(19) United States
(12) Patent Application Publication
(10) Pub. No.: US 2023/0150539 A1
(43) Pub. Date: May 18, 2023

(54) APPARATUS FOR CONTROLLING AUTONOMOUS DRIVING AND METHOD THEREOF

(71) Applicants: HYUNDAI MOTOR COMPANY, Seoul (KR); KIA CORPORATION, Seoul (KR)

(72) Inventor: Tae Dong Oh, Seoul (KR)

(73) Assignees: HYUNDAI MOTOR COMPANY, Seoul (KR); KIA CORPORATION, Seoul (KR)

(21) Appl. No.: 17/848,086

(22) Filed: Jun. 23, 2022

(30) Foreign Application Priority Data
Nov. 15, 2021 (KR) 10-2021-0156934

(51) Int. Cl. B60W 60/00; B60W 50/00

(52) U.S. Cl. CPC B60W 60/0015; B60W 50/0098; B60W 2556/40; B60W 2520/14; B60W 2520/10; B60W 2520/105; B60W 2050/0026; B60W 2554/4045; B60W 2552/10; B60W 2720/106; B60W 2554/4041

(57) ABSTRACT

An autonomous driving control apparatus and method are for determining following-route deviation of an autonomous vehicle. The apparatus and method: may obtain surrounding information of an autonomous vehicle; may calculate a control-following route according to a predetermined driving strategy based on the surrounding information and the high definition map information around an autonomous vehicle; may calculate an expected driving route on which the autonomous vehicle is expected to be driven, when autonomous driving according to the control-following route is performed; may determine whether following-route deviation of the autonomous vehicle is expected, by comparing the control-following route with the expected driving route; and may change the driving strategy based on whether the following-route deviation of the autonomous vehicle is expected.

### CROSS-REFERENCE TO RELATED APPLICATION

This application claims the benefit of priority to Korean Patent Application No. 10-2021-0156934, filed in the Korean Intellectual Property Office on Nov. 15, 2021, the entire contents of which are incorporated herein by reference.

### TECHNICAL FIELD

The present disclosure relates to an autonomous driving control apparatus and a method thereof. More particularly, the present disclosure relates to an autonomous driving control apparatus for determining following-route deviation of an autonomous vehicle and a method thereof.

### BACKGROUND

An autonomous vehicle may first set a control-following route and then may perform autonomous driving of a vehicle in a manner of following the control-following route. In this process, there may be a difference between the control-following route followed by the autonomous vehicle and a route on which an actual vehicle is driving. For this reason, errors may be induced in a process of autonomous driving control. These errors may be caused by dynamics characteristics of the vehicle.

In particular, when there is a difference between the control-following route followed by the autonomous vehicle and a route on which an actual vehicle is driving in various situations such as a lane change situation, a lane return situation, a U-turn situation, a left turn situation, or a right turn situation, there is a need for the response plan for each situation. Accordingly, when there is the difference between the control-following route and the route, on which an actual vehicle is driving, depending on each vehicle driving situation, it is necessary to develop a technology capable of fixing an error that occurs.

### SUMMARY

The present disclosure has been made to solve the above-mentioned problems occurring in the prior art while advantages achieved by the prior art are maintained intact.

An aspect of the present disclosure provides an autonomous driving control apparatus that determines following-route deviation of an autonomous vehicle. Another aspect of the present disclosure provides a method thereof.

Further aspects of the present disclosure provide an autonomous driving control apparatus that stably performs autonomous driving control and provide a method thereof.

Still further aspects of the present disclosure provide an autonomous driving control apparatus that prevents accidents caused by departure from a control-following route in advance by determining the following-route deviation of an autonomous vehicle and provide a method thereof.

Additional aspects of the present disclosure provide an autonomous driving control apparatus that facilitates data acquisition regarding control-following route departure cases and provide a method thereof.

Another aspect of the present disclosure provides an autonomous driving control apparatus that is capable of, in real time, coping with situations in which a vehicle deviates from a control-following route even when it is impossible to predict whether the vehicle deviates from the control-following route, in advance. Yet another aspect of the present disclosure provides a method thereof.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an autonomous driving control apparatus may include: a sensor obtaining surrounding information of an autonomous vehicle; a storage storing high definition map information around the autonomous vehicle; and a controller that calculates a control-following route according to a predetermined driving strategy based on the surrounding information and the high definition map information. The controller also calculates an expected driving route on which the autonomous vehicle is expected to be driven, when autonomous driving according to the control-following route is performed. The controller also determines whether following-route deviation of the autonomous vehicle is expected, by comparing the control-following route with the expected driving route. The controller also changes the driving strategy based on whether the following-route deviation of the autonomous vehicle is expected.

In an embodiment, the controller may calculate or estimate a departure angle over time and a departure distance over time by using a dynamics model of the autonomous vehicle and may calculate or estimate the expected driving route based on the departure angle over time and the departure distance over time.

In an embodiment, the controller may calculate an expected driving route by applying at least one of a yaw rate, a departure distance, a departure angle, a speed, or acceleration of the autonomous vehicle to a predetermined lookup table.

In an embodiment, the controller may calculate the expected driving route by applying at least one of a yaw rate, a departure distance, a departure angle, a speed, or acceleration of the autonomous vehicle to a pre-trained machine learning-based learning model. The pre-trained machine learning-based learning model may use a location difference between a point on the control-following route and a corresponding point on the expected driving route as an output.

In an embodiment, the controller may change the driving strategy in consideration of a risk of collision with another vehicle determined based on the expected driving route and vertices of a virtual box including all or part of the another vehicle when the following-route deviation of the autonomous vehicle is expected and when the autonomous vehicle makes a U-turn.

In an embodiment, the controller may decelerate the autonomous vehicle and may change the driving strategy in consideration of the risk of collision with the another vehicle that is determined based on an actual boundary point of the another vehicle such that the autonomous vehicle is driven at low speed or is stopped, when one or more of the vertices are included in a region inside the expected driving route set in consideration of a specific margin. The controller may also change the driving strategy based on an extent to which the vertices violate the expected driving route, such that the autonomous vehicle is driven to lean in an opposite direction of the another vehicle in the control-following route, when one or more of the vertices are not included in the region inside the expected driving route set in consideration of the specific margin.

In an embodiment, the controller may determine whether a cut-in vehicle crosses or merges between the autonomous vehicle and a preceding vehicle based on a cross point between the expected driving route and a driving route of the cut-in vehicle and a nearest point with the preceding vehicle on the expected driving route, when the following-route deviation the autonomous vehicle is expected and when the autonomous vehicle turns to a left or a right. The controller may also change the driving strategy in consideration of whether the determined cut-in vehicle crosses or merges between the autonomous vehicle and the preceding vehicle.

In an embodiment, the controller may change the driving strategy based on whether time periods, at which the autonomous vehicle and the cut-in vehicle occupy the cross point, overlap each other, such that the autonomous vehicle is driven at a low speed or is stopped, when it is determined that the cut-in vehicle crosses or merges between the autonomous vehicle and the preceding vehicle. The controller may also change the driving strategy in consideration of a speed of the preceding vehicle such that the autonomous vehicle is decelerated, when it is determined that the cut-in vehicle does not cross or merge between the autonomous vehicle and the preceding vehicle.

In an embodiment, the controller may change the driving strategy in consideration of a point with a closest vertical distance to the expected driving route among vertices of a virtual box including all or part of another vehicle and whether there is a cut-in vehicle in an existing lane, when the following-route deviation of the autonomous vehicle is expected and when the autonomous vehicle returns to the existing lane during a lane change.

In an embodiment, the controller may change the driving strategy such that the autonomous vehicle is decelerated, while performing the lane change, when the closest point is positioned in an internal region of the expected driving route set in consideration of a specific margin. The controller may also change the driving strategy based on a cross point between the expected driving route and a driving route of the cut-in vehicle such that the autonomous vehicle is decelerated, while performing a lane return, when the closest point is not positioned in the internal region and when the cut-in vehicle is present. The controller may also maintain the driving strategy of the lane return, when the closest point is not positioned in the internal region and when the cut-in vehicle is not present.

In an embodiment, the controller may change the driving strategy in consideration of a point with a closest vertical distance to the expected driving route among vertices of a virtual box including all or part of another vehicle, and whether there is a cut-in vehicle in a target lane of the lane change, when the following-route deviation of the autonomous vehicle is expected and when the autonomous vehicle changes lanes while being stopped.

In an embodiment, the controller may change the driving strategy such that the autonomous vehicle is decelerated, while not performing the lane change, when the closest point is positioned in an internal region of the expected driving route set in consideration of a specific margin. The controller may also change the driving strategy based on a cross point between the expected driving route and a driving route of the cut-in vehicle such that the autonomous vehicle is decelerated or is driven after stopping during a specific time, while performing the lane change, when the closest point is not positioned in the internal region and when the cut-in vehicle is present. The controller may also maintain the driving strategy of the lane change, when the closest point is not positioned in the internal region and when the cut-in vehicle is not present.

In an embodiment, the controller may change the driving strategy so as to perform a minimal risk maneuver (MRM) control, when a difference between the control-following route and the expected driving route exceeds a predetermined threshold value.

According to an aspect of the present disclosure, an autonomous driving control method may include obtaining, by a sensor, surrounding information of an autonomous vehicle. The method may also include calculating, by a controller, a control-following route according to a predetermined driving strategy based on the surrounding information and high definition map information around the autonomous vehicle. The method may also include calculating, by the controller, an expected driving route on which the autonomous vehicle is expected to be driven, when autonomous driving according to the control-following route is performed. The method may also include determining, by the controller, whether following-route deviation of the autonomous vehicle is expected, by comparing the control-following route with the expected driving route. The method may also include changing, by the controller, the driving strategy based on whether the following-route deviation of the autonomous vehicle is expected.

In an embodiment, the calculating, by the controller, of the expected driving route may include calculating, by the controller, a departure angle over time and a departure distance over time by using a dynamics model of the autonomous vehicle and may also include calculating, by the controller, the expected driving route based on the departure angle over time and the departure distance over time.

In an embodiment, the calculating, by the controller, of the expected driving route may include calculating, by the controller, the expected driving route by applying at least one of a yaw rate, a departure distance, a departure angle, a speed, or acceleration of the autonomous vehicle to a pre-trained machine learning-based learning model that uses a predetermined lookup table or a location difference between a point on the control-following route and a corresponding point on the expected driving route as an output.

In an embodiment, the changing, by the controller, of the driving strategy may include changing, by the controller, the driving strategy in consideration of a risk of collision with another vehicle determined based on the expected driving route and vertices of a virtual box including all or part of the another vehicle when the following-route deviation of the autonomous vehicle is expected and when the autonomous vehicle makes a U-turn.

In an embodiment, the changing, by the controller, of the driving strategy may include determining, by the controller, whether a cut-in vehicle crosses or merges between the autonomous vehicle and a preceding vehicle based on a cross point between the expected driving route and a driving route of the cut-in vehicle and a nearest point with the preceding vehicle on the expected driving route, when the following-route deviation the autonomous vehicle is expected and when the autonomous vehicle turns to a left or a right. The changing, by the controller, of the driving strategy may also include changing, by the controller, the driving strategy in consideration of whether the determined cut-in vehicle crosses or merges between the autonomous vehicle and the preceding vehicle.

In an embodiment, the changing, by the controller, of the driving strategy may include changing, by the controller, the driving strategy in consideration of a point with a closest vertical distance to the expected driving route among vertices of a virtual box including all or part of another vehicle and whether there is a cut-in vehicle in an existing lane, when the following-route deviation of the autonomous vehicle is expected and when the autonomous vehicle returns to the existing lane during a lane change.

In an embodiment, the changing, by the controller, of the driving strategy may include changing, by the controller, the driving strategy so as to perform a MRM control, when a difference between the control-following route and the expected driving route exceeds a predetermined threshold value.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating an autonomous driving control apparatus, according to an embodiment of the present disclosure;

FIG. 2 is a diagram illustrating a detailed configuration and operation of an autonomous driving control apparatus, according to an embodiment of the present disclosure;

FIG. 3 is a flowchart illustrating an operation of an autonomous driving control apparatus, according to an embodiment of the present disclosure;

FIG. 4 is a flowchart illustrating that an autonomous driving control apparatus uses an expected driving route of a previous frame, according to an embodiment of the present disclosure;

FIGS. 5A and 5B are diagrams illustrating a need for an autonomous driving control apparatus to reconvert a coordinate system between frames, according to an embodiment of the present disclosure;

FIG. 6 is a diagram illustrating a dynamics model of a vehicle used by an autonomous driving control apparatus, according to an embodiment of the present disclosure;

FIG. 7 is a diagram illustrating that an autonomous driving control apparatus estimates an expected driving route through a numerical analysis method, according to an embodiment of the present disclosure;

FIG. 8 is a diagram illustrating that an autonomous driving control apparatus calculates an expected driving route through a lookup table, according to an embodiment of the present disclosure;

FIG. 9 is a diagram illustrating that an autonomous driving control apparatus calculates an expected driving route through machine learning, according to an embodiment of the present disclosure;

FIG. 10 is a diagram illustrating a case in which an autonomous driving control apparatus is capable of calculating an expected driving route and illustrating a case in which the autonomous driving control apparatus is incapable of calculating the expected driving route, according to an embodiment of the present disclosure;

FIGS. 11-14 are diagrams illustrating that an autonomous driving control apparatus operates when a departure occurs in a U-turn situation, according to an embodiment of the present disclosure;

FIGS. 15-18 are diagrams illustrating that an autonomous driving control apparatus operates when a departure occurs in a left turn or right turn situation, according to an embodiment of the present disclosure;

FIGS. 19-23 are diagrams illustrating that an autonomous driving control apparatus operates when a departure occurs in a situation of returning to an existing lane during a lane change, according to an embodiment of the present disclosure;

FIGS. 24-28 are diagrams illustrating that an autonomous driving control apparatus operates when a departure occurs in a situation of a lane change in a stopped state, according to an embodiment of the present disclosure;

FIGS. 29 and 30 are diagrams illustrating that an autonomous driving control apparatus operates when a deviation occurs to an extent exceeding a predetermined threshold value, according to an embodiment of the present disclosure; and

FIG. 31 is a flowchart illustrating an autonomous driving control method, according to an embodiment of the present disclosure.

### DETAILED DESCRIPTION

Hereinafter, some embodiments of the present disclosure are described in detail with reference to the accompanying drawings. In adding reference numerals to components of each drawing, it should be noted that the same or equivalent components have the same reference numerals, although they are indicated on another drawing. Furthermore, in describing the embodiments of the present disclosure, detailed descriptions associated with well-known functions or configurations have been omitted when they may make subject matters of the present disclosure unnecessarily obscure.

In describing elements of embodiments of the present disclosure, the terms first, second, A, B, (a), (b), and the like may be used herein. These terms are only used to distinguish one element from another element and do not limit the corresponding elements irrespective of the nature, order, or priority of the corresponding elements. Furthermore, unless otherwise defined, all terms including technical and scientific terms used herein should be interpreted as is customary in the art to which the present disclosure belongs. It should be understood that terms used herein should be interpreted as having a meaning that is consistent with their meaning in the context of the present disclosure and the relevant art and should not be interpreted in an idealized or overly formal sense unless expressly so defined herein. When a component, device, element, or the like of the present disclosure is described as having a purpose or performing an operation, function, or the like, the component, device, or element should be considered herein as being “configured to” meet that purpose or to perform that operation or function. The present disclosure describes various components of an object tracking apparatus as modules, such as: a high definition map transmission module; a precise map transmission module; a location recognition module; a road information fusion module; an object fusion module; an object-behavior-around-host-vehicle determination module; a driving strategy determination module; a speed profile calculation module; a control-following route calculation module; an expected driving route calculation module; a following-route deviation determination module; a departure driving strategy determination module; a control-following route and speed profile generation module; and a route-following control module. Each of these modules may separately embody or in combination with other such modules be included with a processor and a memory, such as a non-transitory computer readable media, as part of the apparatus.

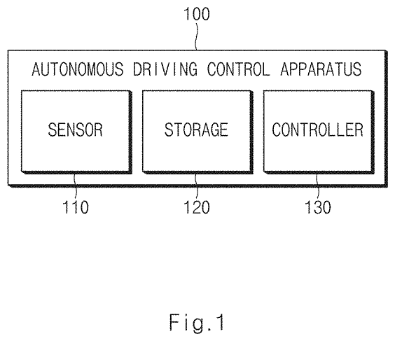

Hereinafter, various embodiments of the present disclosure are described in detail with reference to FIGS. 1-31.

FIG. 1 is a block diagram illustrating an autonomous driving control apparatus, according to an embodiment of the present disclosure.

An autonomous driving control apparatus 100 according to an embodiment of the present disclosure may be implemented inside or outside a vehicle. At this time, the autonomous driving control apparatus 100 may be integrated with internal control units of a vehicle and may be implemented with a separate hardware device so as to be connected to control units of the vehicle by means of a connection means.

For example, the autonomous driving control apparatus 100 may be implemented integrally with a vehicle or may be implemented in a form installed/attached to the vehicle as a configuration separate from the vehicle. Alternatively, a part of the autonomous driving control apparatus 100 may be implemented integrally with the vehicle, and the other parts may be implemented in a form installed/attached to the vehicle as a configuration separate from the vehicle.

Referring to FIG. 1, an autonomous driving control apparatus 100 may include a sensor 110, storage 120, and a controller 130.

The sensor 110 may obtain surrounding information of an autonomous vehicle.

For example, the sensor 110 may include at least one of a light detection and ranging (LiDAR), a radar, or a camera.

For example, the sensor 110 may obtain information about a distance to the obstacle or may obtain information about whether an obstacle such as another vehicle or an object around an autonomous vehicle is present, through at least one of the LiDAR, the radar, or the camera.

For example, the sensor 110 may be directly or indirectly connected to the controller 130 through wired or wireless communication and may transmit the obtained information to the controller 130.

For example, the storage 120 may include at least one type of a storage medium among a flash memory type of a memory, a hard disk type of a memory, a micro type of a memory, and a card type (e.g., a Secure Digital (SD) card or an eXtream Digital (XD) card) of a memory, a Random Access Memory (RAM) type of a memory, a Static RAM (SRAM) type of a memory, a Read-Only Memory (ROM) type of a memory, a Programmable ROM (PROM) type of a memory, an Electrically Erasable PROM (EEPROM) type of a memory, an Magnetic RAM (MRAM) type of a memory, a magnetic disk type of a memory, and/or an optical disc type of a memory.

For example, the storage 120 may store data and/or algorithms required in a process in which the sensor 110 and the controller 130 are operating

The storage 120 may store high definition map information around an autonomous vehicle.

For example, the storage 120 may be connected to the controller 130. Accordingly, the controller 130 is configured to access the storage 120 and then to use the stored information.

The controller 130 may perform overall control such that each of the components is capable of normally performing functions of the components. The controller 130 may be implemented in the form of hardware, may be implemented in the form of software, or may be implemented in the form of the combination of hardware and software. In an embodiment, the controller 130 may be implemented as a microprocessor but is not limited thereto. In addition, the controller 130 may perform various data processing and calculations that are described below.

The controller 130 may calculate a control-following route according to a predetermined driving strategy based on surrounding information and high definition map information.

For example, to autonomously drive to a destination, the controller 130 may calculate a control-following route according to a predetermined driving strategy based on surrounding information and high definition map information.

Here, the controller 130 may calculate a control-following route to the destination through an autonomous driving route setting algorithm that is existing or to be developed.

When autonomous driving according to the control-following route is performed, the controller 130 may calculate an expected driving route on which the autonomous vehicle is expected to be driven.

For example, when the autonomous vehicle is autonomously driven along the control-following route, the controller 130 may actually calculate the expected driving route on which the autonomous vehicle will be driven, in consideration of the dynamic properties of the autonomous vehicle, or the like.

For example, the controller 130 may calculate or estimate a departure angle over time and a departure distance over time by using a dynamics model of the autonomous vehicle and then may calculate or estimate the expected driving route based on the departure angle over time and the departure distance over time.

For example, when the controller 130 is capable of obtaining the departure angle over time and the departure distance over time depending on the vehicle dynamics model in a closed form, the controller 130 may calculate the departure angle over time and the departure distance over time by using the dynamics model of the autonomous vehicle and then may calculate an expected driving route based on the departure angle over time and departure distance over time.

For example, the controller 130 does not obtain the departure angle over time and departure distance over time depending on the vehicle dynamics model in the closed form, but the vehicle dynamics model is present. The controller 130 is capable of estimating the departure distance per time interval. The controller 130 may estimate the departure angle over time and the departure distance over time by using the dynamics model of the autonomous vehicle and then may estimate the expected driving route based on the departure angle over time and the departure distance over time.

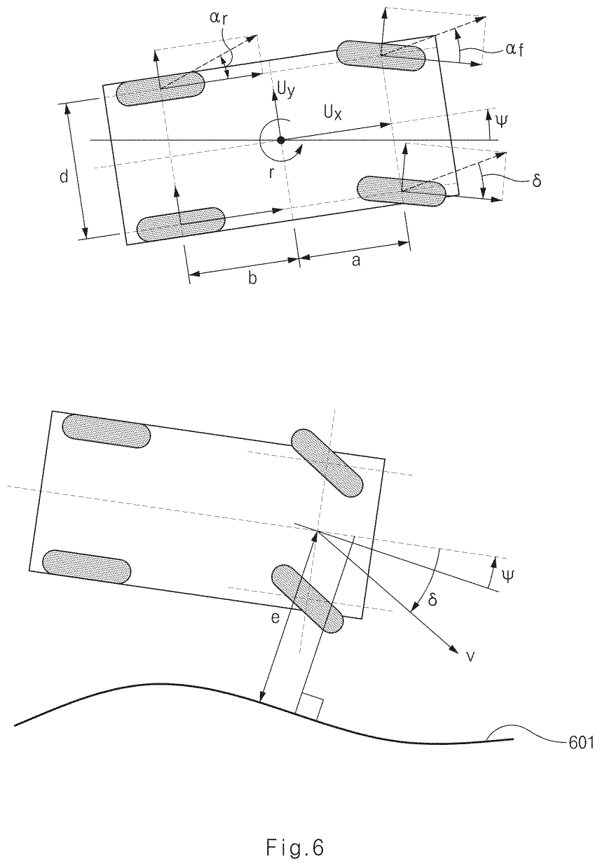

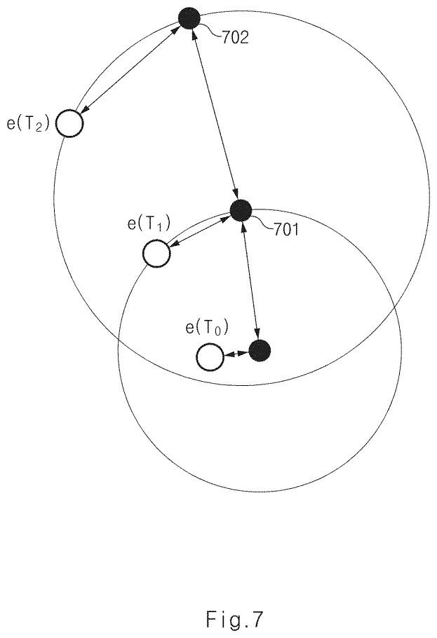

It is described in detail below with reference to FIGS. 6 and 7 that the controller 130 calculates or estimates an expected driving route by using the dynamics model of the autonomous vehicle.

As another example, the controller 130 may calculate an expected driving route by applying at least one of the autonomous vehicle's yaw rate, departure distance, departure angle, speed, or acceleration to a predetermined lookup table.

For example, when it is impossible to calculate or estimate an expected driving route through the dynamics model of an autonomous vehicle, or it is determined that the reliability of the calculated or estimated expected driving route is less than a predetermined threshold value due to external variables (friction, a slip angle, and the like), through the dynamics model of the autonomous vehicle, the controller 130 may calculate the expected driving route by using a predetermined lookup table.

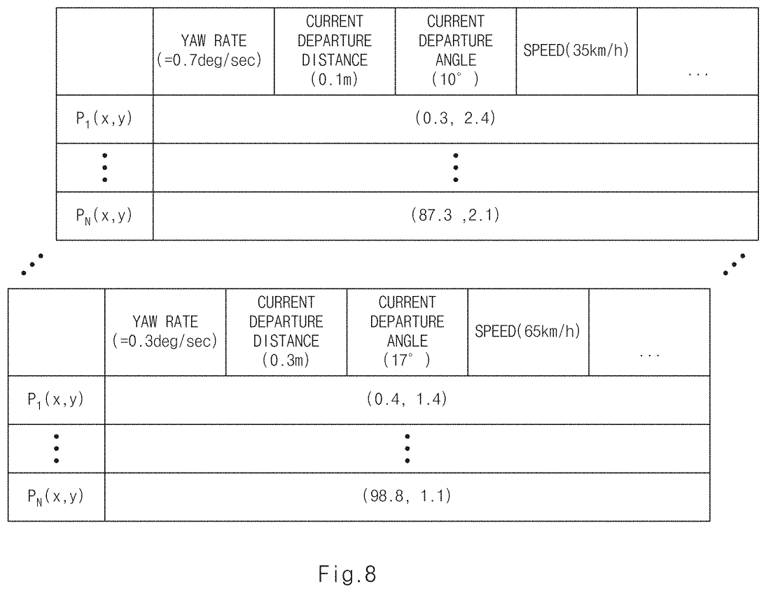

It is described in detail below with reference to FIG. 8 that the controller 130 calculates an expected driving route by using a predetermined lookup table.

As another example, the controller 130 may calculate the expected driving route by applying at least one of the autonomous vehicle's yaw rate, departure distance, departure angle, speed, or acceleration to a pre-trained machine learning-based learning model that uses a location difference between a point on a control-following route and a corresponding point on an expected driving route as an output.

For example, instead of a method of using a lookup table, the controller 130 may calculate the expected driving route through the pre-trained machine learning-based learning model.

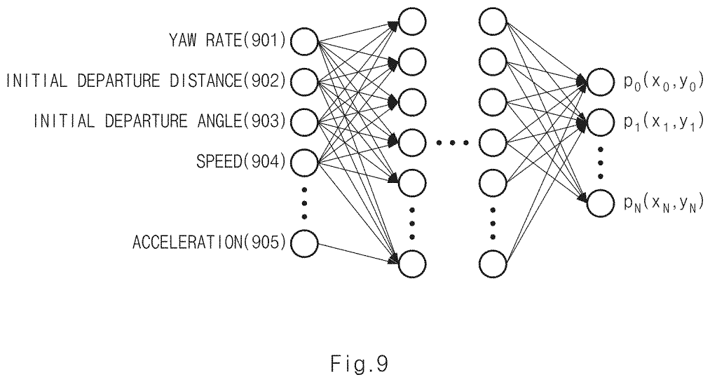

It is described in detail below with reference to FIG. 9 that the controller 130 calculates an expected driving route by using a pre-trained machine learning-based learning model.

The controller 130 may determine whether the autonomous vehicle's following-route deviation is expected, by comparing the control-following route with the expected driving route.

For example, the controller 130 may compare a distance between points, which correspond to each other, on the control-following route and the expected driving route. When the distance exceeds a predetermined threshold value, the controller 130 may determine that the autonomous vehicle's following-route deviation is expected.

As another example, the controller 130 may accumulate the distance between points, which correspond to each other, on the control-following route and the expected driving route. When the accumulated distance exceeds a predetermined threshold value, the controller 130 may also determine that the autonomous vehicle's following-route deviation is expected.

The controller 130 may change the driving strategy based on whether the autonomous vehicle's following-route deviation is expected.

For example, the controller 130 may identify a driving case of a current autonomous vehicle through an autonomous driving system.

For example, the controller 130 may determine the driving case of the current autonomous vehicle based on at least one of the high definition map information of the autonomous vehicle, the current location of the autonomous vehicle, or a route on which the autonomous vehicle is currently being driven.

For example, the controller 130 may determine whether the current autonomous vehicle's driving case is a U-turn situation, whether it is a left-turn situation, whether it is a right-turn situation, whether it is a situation of returning to the existing lane while a vehicle is changing lanes, and whether it is a situation of changing to a lane in a stop state. When the following-route deviation of the autonomous vehicle is expected, the controller 130 may change the driving strategy in response to the corresponding situation.

For example, when the autonomous vehicle's following-route deviation is expected and when the autonomous vehicle makes a U-turn, the controller 130 may change the driving strategy in consideration of a risk of collision with another vehicle determined based on the expected driving route and vertices of a virtual box including some or all of other vehicles.

For example, the controller 130 may set a rectangular virtual box including some or all of other vehicles based on the information obtained through the sensor 110. Moreover, the controller 130 may determine whether at least one of four vertices of the virtual box is included in a region inside the expected driving route set in consideration of a specific margin.

For example, when one or more of vertices are included in a region inside the expected driving route set in consideration of a specific margin, the controller 130 may decelerate the autonomous vehicle and then may change a driving strategy in consideration of a risk of collision with another vehicle that is determined based on an actual boundary point of the other vehicle such that the autonomous vehicle is driven at low speed or is stopped.

For example, when one or more of the vertices are not included in a region inside the expected driving route set in consideration of the specific margin, the controller 130 may change the driving strategy based on an extent to which a vertex has violated the expected driving route, such that the autonomous vehicle is driven to lean (i.e., deflect in the driving lane) in the opposite direction of the other vehicle in the control-following route.

For example, when one or more of the vertices are included in the region inside the expected driving route set in consideration of the specific margin, the controller 130 may determine that there is a risk of collision between the autonomous vehicle and another vehicle and then may slow down or stop the autonomous vehicle. When the risk is relieved from a relationship with the autonomous vehicle after stopping, the controller 130 may make a U-turn again.

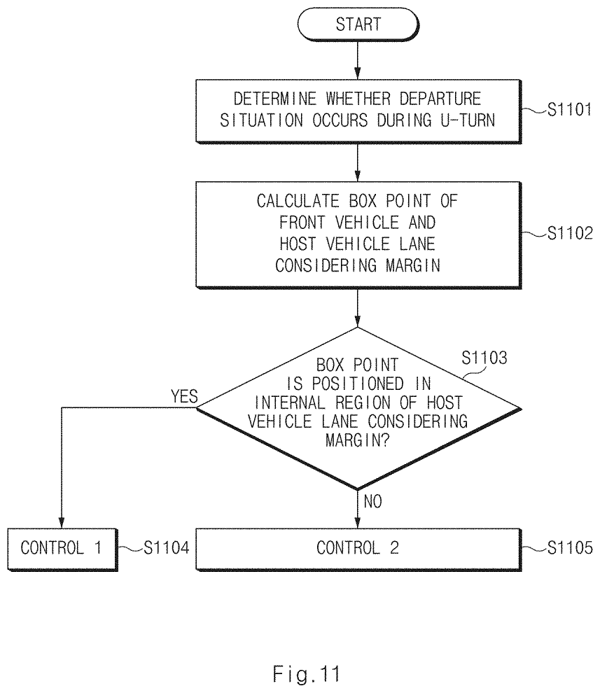

It is described in detail below with reference to FIGS. 11-14 that the controller 130 changes a driving strategy when a departure occurs in a U-turn situation.

For example, when the autonomous vehicle's following-route deviation is expected and when the autonomous vehicle turns to the left or the right, the controller 130 may determine whether a cut-in vehicle crosses or merges between an autonomous vehicle and a preceding vehicle. The determination is based on a cross point between the expected driving route and a driving route of the cut-in vehicle and the nearest point with the preceding vehicle on the expected driving route. Then, the controller 130 may change the driving strategy in consideration of whether the determined cut-in vehicle crosses or merges between the autonomous vehicle and the preceding vehicle.

The cut-in vehicle may mean a vehicle that infringes on the driving route of the autonomous vehicle.

For example, the controller 130 may grasp the driving route of the cut-in vehicle through high definition map information and vehicle-to-everything (V2X) communication with the cut-in vehicle.

For example, when it is determined that the cut-in vehicle crosses or merges between the autonomous vehicle and the preceding vehicle, the controller 130 may change the driving strategy based on whether time periods at which the autonomous vehicle and the cut-in vehicle occupy a cross point overlap each other, such that the autonomous vehicle is driven at low speed or is stopped.

For example, when it is determined that the cut-in vehicle does not cross or merge between the autonomous vehicle and the preceding vehicle, the controller 130 may change the driving strategy in consideration of the speed of the preceding vehicle such that the autonomous vehicle is decelerated.

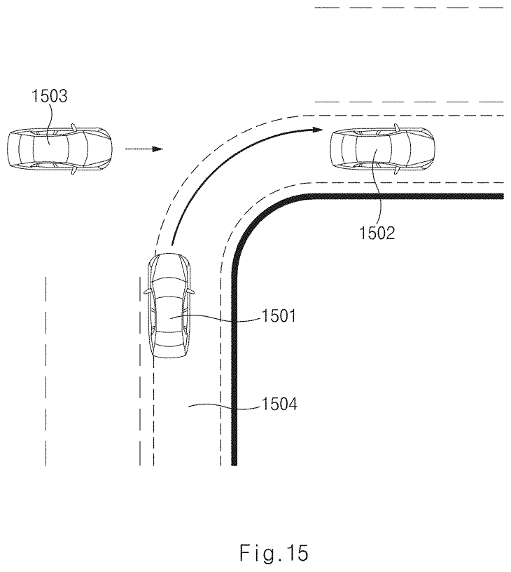

It is described in detail below with reference to FIGS. 15-18 that the controller 130 changes a driving strategy when a departure occurs in a left or right turn situation.

For example, when the following-route deviation of the autonomous vehicle is expected and when the autonomous vehicle returns to the existing lane while changing lanes, the controller 130 may change the driving strategy in consideration of a point with the closest vertical distance to the expected driving route among vertices of the virtual box including some or all of the other vehicle and in consideration of whether there is a cut-in vehicle on the existing lane.

For example, the controller 130 may determine whether a cut-in vehicle is present, through at least one of high definition map information, surrounding information of the autonomous vehicle, or communication with other vehicles through V2X communication.

For example, when the point with the closest vertical distance is positioned in an internal region of the expected driving route set in consideration of the specific margin, while performing the lane change, the controller 130 may change the driving strategy such that the autonomous vehicle is decelerated.

For example, when the point with the closest vertical distance is not positioned in the internal region, and a cut-in vehicle is present, while performing a lane return, the controller 130 may change the driving strategy based on a cross point between the expected driving route and the driving route of the cut-in vehicle such that the autonomous vehicle is decelerated.

For example, when the point with the closest vertical distance is not positioned in the internal region and when a cut-in vehicle is not present, the controller 130 may maintain the driving strategy of the lane return.

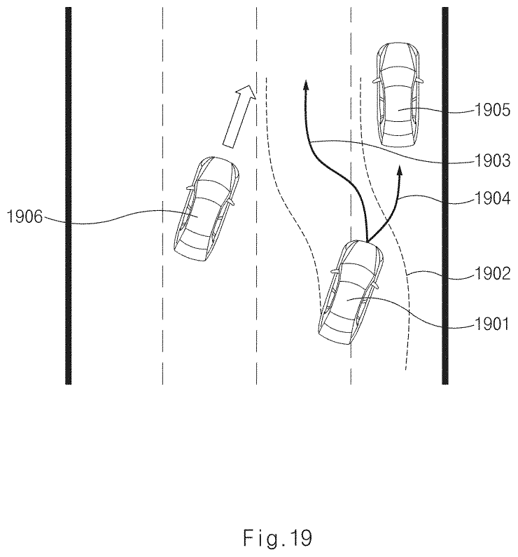

It is described in detail below with reference to FIGS. 19-23 that the controller 130 changes a driving strategy when a departure occurs in a situation of returning to the existing lane while changing lanes.

For example, when the following-route deviation of the autonomous vehicle is expected and when the autonomous vehicle changes lanes while being stopped, the controller 130 may change the driving strategy in consideration of a point with the closest vertical distance to the expected driving route among vertices of the virtual box including some or all of the other vehicle and in consideration of whether there is a cut-in vehicle on a target lane for the lane change.

For example, when the point with the closest vertical distance is positioned in the internal region of the expected driving route set in consideration of the specific margin, while not performing the lane change, the controller 130 may change the driving strategy such that the autonomous vehicle is decelerated.

For example, when the point with the closest vertical distance is not positioned in the internal region and when a cut-in vehicle is present, while changing lanes, the controller 130 may change the driving strategy based on a cross point between the expected driving route and the driving route of the cut-in vehicle such that the autonomous vehicle is decelerated or is driven after stopping during a specific time.

For example, when the closest point is not positioned in the internal region and when a cut-in vehicle is not present, the controller 130 may maintain the driving strategy of changing lanes.

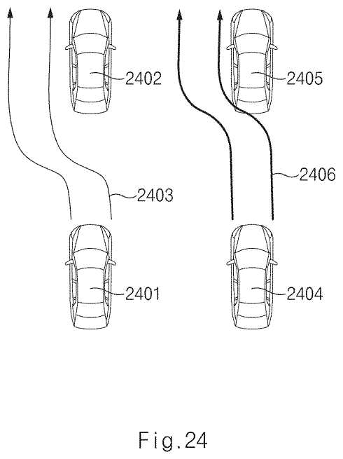

It is described in detail below with reference to FIGS. 24-28 that the controller 130 changes a driving strategy in a stopped state when a departure occurs in a situation of changing lanes.

For example, when a difference between the control-following route and the expected driving route exceeds a predetermined threshold value, the controller 130 may change the driving strategy so as to perform minimal risk maneuver (MRM) control.

When a risk with a specific level or more is detected by using a predetermined algorithm, the MRM control may mean vehicle control for preventing major accidents such as stopping after decelerating in a driving lane or stopping after changing to a shoulder lane.

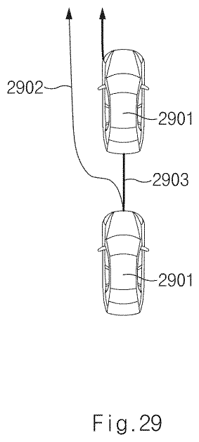

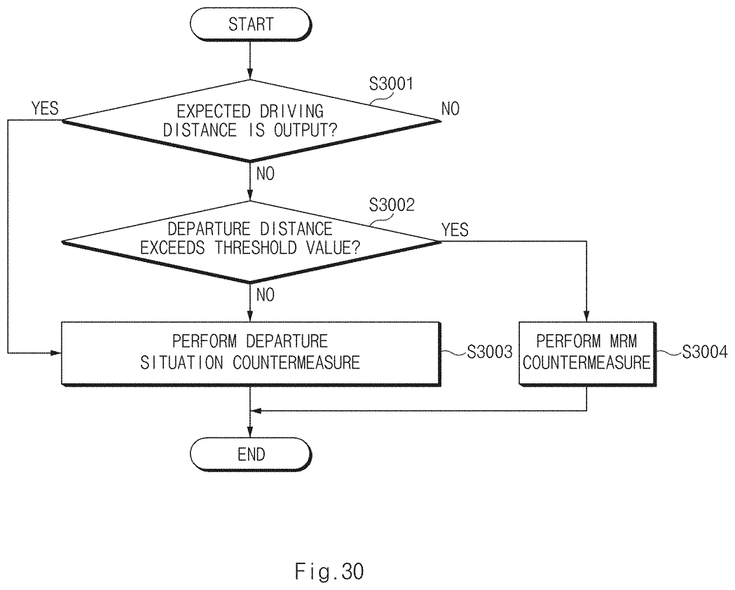

It is described in detail below with reference to FIGS. 29 and 30 that the controller 130 changes a driving strategy when the difference between the control-following route and the expected driving route exceeds the predetermined threshold value.

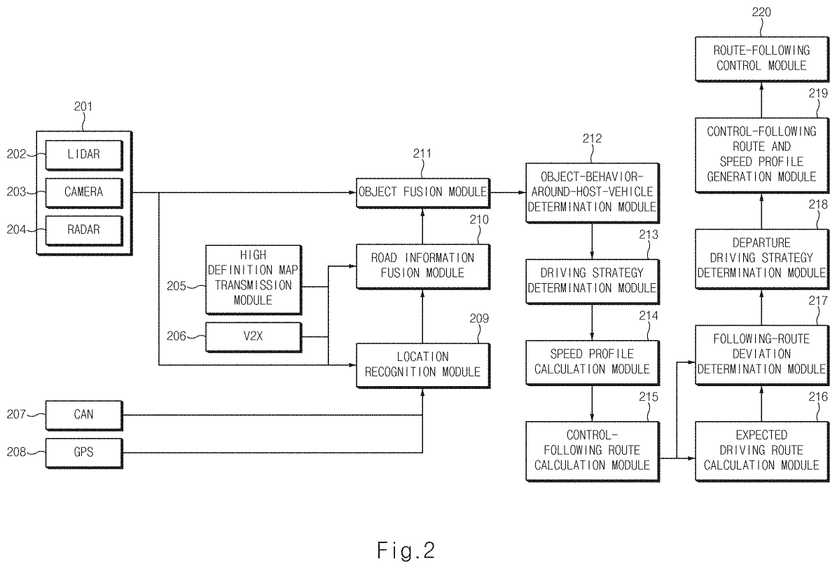

FIG. 2 is a diagram illustrating a detailed configuration and operation of an autonomous driving control apparatus, according to an embodiment of the present disclosure.

Referring to FIG. 2, a sensor 201 may include a LiDAR 202, a camera 203, and radar 204.

Recognition information about other vehicles obtained through the LiDAR 202, the camera 203, and the radar 204 of the sensor 201 may be transmitted to an object fusion module 211 and a location recognition module 209.

A high definition map transmission module (e.g., precise map transmission module) 205 may transmit information about an autonomous vehicle-centered high definition map to a road information fusion module 210 and the location recognition module 209.

A V2X 206 may transmit information about other vehicles obtained through V2X communication to the road information fusion module 210 and the location recognition module 209.

The location recognition module 209 may be connected to communication of a controller area network (CAN) 207 of the autonomous vehicle so as to perform a communication function. The location recognition module 209 may be connected to a global positioning system (GPS) 208 of the autonomous vehicle so as to obtain location information of the autonomous vehicle.

The location recognition module 209 may compare recognition information obtained through the sensor 201, information obtained through the GPS 208, and high definition map information transmitted from the high definition map transmission module 205. Then, the location recognition module 209 may output location information of the autonomous vehicle and the reliability of location recognition together. Then, the recognition module 209 may transmit the location information of the autonomous vehicle and the reliability of location recognition to the road information fusion module 210.

The road information fusion module 210 may output high definition map information around the autonomous vehicle through location recognition information and high definition map information and may transmit the high definition map information to the object fusion module 211.

The object fusion module 211 may fuse and output an object on a high definition map through the recognition information obtained through the sensor 201 and the high definition map information around the autonomous vehicle received from the road information fusion module 210. Then, the object fusion module 211 may transmit the output information to an object-behavior-around-host-vehicle determination module 212.

For example, an object may include other vehicles around the autonomous vehicle.

The object-behavior-around-host-vehicle determination module 212 may calculate the driving intent and behavior information of the object by using the fused and output object on the high definition map and then may transmit the calculated information to a driving strategy determination module 213.

The driving strategy determination module 213 may determine a driving strategy based on a situation of a surrounding object, a location of the host vehicle on a high definition map, and a driving route of the host vehicle and then may transmit information about the determined driving strategy to a speed profile calculation module 214.

The speed profile calculation module 214 may generate a speed profile according to the driving strategy and then may transmit information about the generated speed profile to a control-following route calculation module 215.

The control-following route calculation module 215 may calculate the control-following route, which satisfies the speed profile and is to be followed by the host vehicle. The control-following route calculation module 215 may transmit information about the calculated control-following route to an expected driving route calculation module 216 and a following-route deviation determination module 217.

When performing autonomous driving control according to the control-following route, the expected driving route calculation module 216 may calculate the expected driving route of the host vehicle and may transmit information about the calculated expected driving route to the following-route deviation determination module 217.

The following-route deviation determination module 217 may determine whether a vehicle deviates from the following route, by comparing the control-following route with the expected driving routes, and then may transmit the determined result to a departure driving strategy determination module 218.

When the following-route deviation of the host vehicle is expected, the departure driving strategy determination module 218 may calculate the modified driving strategy and then may transmit information about the modified driving strategy to a control-following route and speed profile generation module 219.

The control-following route and speed profile generation module 219 may recalculate a drivable speed profile and the control-following route by reflecting the modified driving strategy and then may transmit information about the recalculated speed profile and the recalculated control-following route to a route-following control module 220.

The route-following control module 220 may control autonomous driving based on the recalculated speed profile and the recalculated control-following route.

The configurations of the modules 209-220 may be implemented through the controller 130, and each module may be implemented in a form of software or hardware.

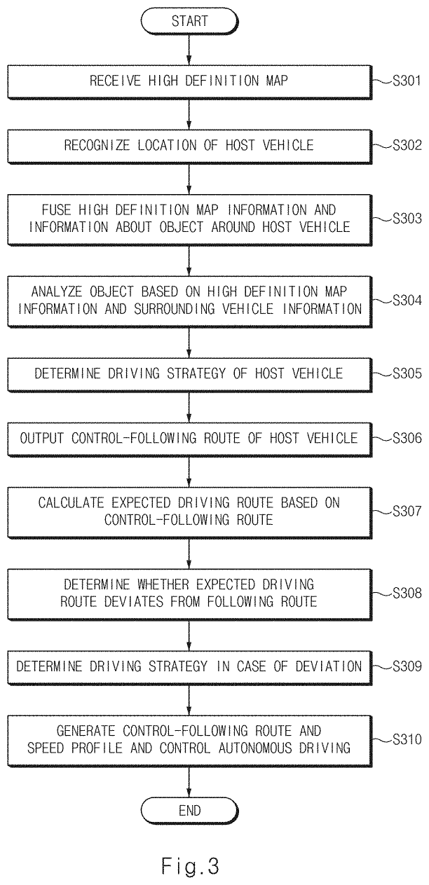

FIG. 3 is a flowchart illustrating an operation of an autonomous driving control apparatus, according to an embodiment of the present disclosure.

Referring to FIG. 3, the autonomous driving control apparatus 100 may receive high definition map information (S301).

For example, the autonomous driving control apparatus 100 may receive the high definition map information from a server.

The autonomous driving control apparatus 100 may receive the high definition map information (S301) and then may recognize a location of a host vehicle (S302).

For example, the autonomous driving control apparatus 100 may recognize the location of the host vehicle through a GPS equipped in an autonomous vehicle.

The autonomous driving control apparatus 100 may recognize the location of the host vehicle (S302) and then may fuse high definition map information and information about an object around the host vehicle (S303).

For example, the autonomous driving control apparatus 100 may fuse host vehicle location information and surrounding object information with the high definition map information and then may calculate fusion information for comparing and analyzing a map, the host vehicle, and an object together.

The autonomous driving control apparatus 100 may fuse the high definition map information and the information about the object around the host vehicle (S303) and then may analyze the object based on the high definition map information and the surrounding vehicle information (S304).

For example, the autonomous driving control apparatus 100 may analyze at least one of the object's behavior, driving intent, or driving route based on the high definition map information and the surrounding object information.

The autonomous driving control apparatus 100 may analyze the object based on the high definition map information and the surrounding vehicle information (S304) and then may determine a driving strategy of the host vehicle (S305).

For example, the autonomous driving control apparatus 100 may determine the driving strategy of the host vehicle based on at least one of the object's behavior, driving intent, or driving route.

The autonomous driving control apparatus 100 may determine the driving strategy of the host vehicle (S305) and then may calculate a control-following route of the host vehicle (S306).

For example, the autonomous driving control apparatus 100 may calculate the control-following route and a speed profile according to the driving strategy.

The autonomous driving control apparatus 100 may calculate the control-following route of the host vehicle (S306) and then may calculate an expected driving route based on the control-following route (S307).

For example, when performing autonomous driving control depending on the control-following route, the autonomous driving control apparatus 100 may actually calculate a route on which the autonomous vehicle will be driven in consideration of the dynamic properties of the autonomous vehicle.

The autonomous driving control apparatus 100 may calculate the expected driving route based on the control-following route (S307) and then may determine whether the expected driving route deviates from a following route (S308).

For example, the autonomous driving control apparatus 100 may determine whether the expected driving route deviates from the following route, by comparing a distance between the expected driving route and the control-following route.

The autonomous driving control apparatus 100 may determine whether the expected driving route deviated from the following route (S308) and then may determine the driving strategy in case of following-route deviation (S309).

For example, when it is determined that the expected driving route deviates from the following route, the autonomous driving control apparatus 100 may modify the driving strategy depending on each driving situation.

After determining the driving strategy (S309), the autonomous driving control apparatus 100 may generate a control-following route and a speed profile and may control autonomous driving (S310).

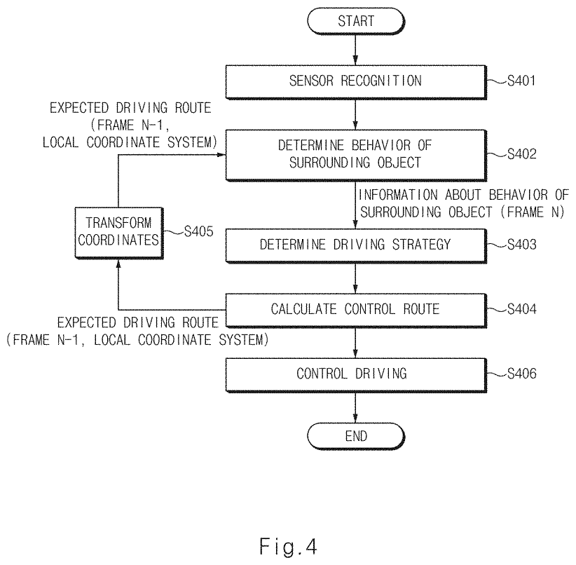

FIG. 4 is a flowchart illustrating that an autonomous driving control apparatus uses an expected driving route of a previous frame, according to an embodiment of the present disclosure.

Referring to FIG. 4, the autonomous driving control apparatus 100 may recognize surroundings of the autonomous vehicle through a sensor (S401).

The autonomous driving control apparatus 100 may perform sensor recognition (S401) and then may determine the behavior of a surrounding object (S402).

At this time, the autonomous driving control apparatus 100 may determine (frame N) the behavior of the surrounding object based on the expected driving route on a global coordinate system calculated in the previous frame (frame N−1).

The autonomous driving control apparatus 100 may determine the behavior of the surrounding object (S402) and then may determine a driving strategy (S403).

The autonomous driving control apparatus 100 may determine the driving strategy (S403) and then may calculate a control route (S404).

For example, the autonomous driving control apparatus 100 may first determine a control-following route. When controlling autonomous driving depending on a control-following route, the autonomous driving control apparatus 100 may calculate the expected driving route on which the autonomous vehicle is expected to actually be driven.

The autonomous driving control apparatus 100 may calculate the control route (S404) and then may perform coordinate transformation (S405).

For example, the autonomous driving control apparatus 100 may perform coordinate system transformation on the expected driving route output on a local coordinate system such that the expected driving route is output on a global coordinate system.

After performing the coordinate transformation (S405), the autonomous driving control apparatus 100 may return to S402 again and may determine the behavior of the surrounding object.

The autonomous driving control apparatus 100 may calculate the control route (S404) and then may perform driving control (S406).

For example, the autonomous driving control apparatus 100 may perform autonomous driving control depending on the control-following route and the driving strategy.

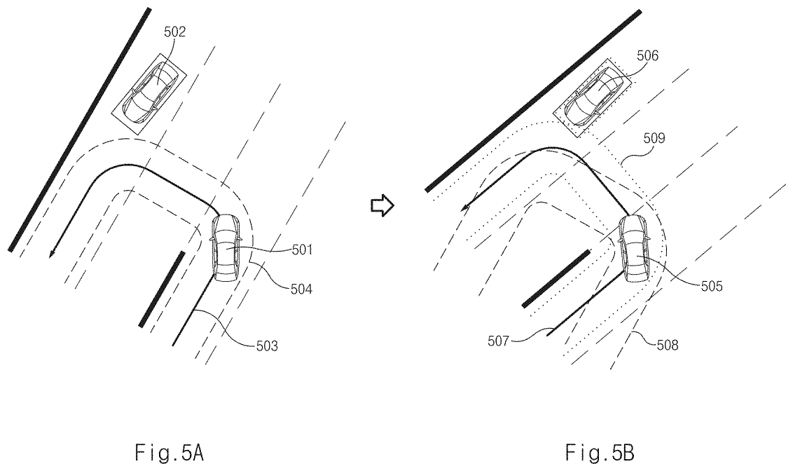

FIGS. 5A and 5B are diagrams illustrating a need for an autonomous driving control apparatus to reconvert a coordinate system between frames, according to an embodiment of the present disclosure.

FIG. 5A illustrates a lane 504 according to an expected driving route 503 of an autonomous vehicle 501 in frame N−1 when a local coordinate system is used instead of using a global coordinate system.

Another vehicle 502 does not invade the lane 504 according to the expected driving route 503 of the autonomous vehicle 501 in frame N−1, and thus it may be determined that the other vehicle 502 is not dangerous.

FIG. 5B illustrates a lane 508 according to an expected driving route 507 of an autonomous vehicle 505 in frame N−1 and a lane 509 according to the expected driving route 507 of the autonomous vehicle 505 in frame N when the global coordinate system is used.

Another vehicle 506 does not invade the lane 508 according to the expected driving route 507 of the autonomous vehicle 505 in frame N−1. However, the other vehicle 506 is invading the lane 509 according to the expected driving route 507 of the autonomous vehicle 505 in frame N. Therefore, it may be determined whether the vehicle 506 is dangerous, differently in each frame.

The autonomous driving control apparatus 100 may obtain information about an object or a surrounding vehicle of the autonomous vehicle in a form of a relative distance from the autonomous vehicle.

In contrast, the high definition map information may be stored in a form of absolute coordinates.

Accordingly, in a process of fusing information about an object or a surrounding vehicle of the autonomous vehicle, which is obtained through a sensor, with a high definition map, when the autonomous driving control apparatus 100 does not correct an integrated lane depending on a location change of the autonomous vehicle, an error in in-pass determination or bias determination with respect to the target may occur.

In other words, the autonomous driving control apparatus 100 may store the integrated lane by using the global coordinates on a high definition map by using the global coordinate system and then may fetch and use a high definition map of global coordinates and integrated lane information, which are stored for each frame.

In a situation of a U-turn, left turn, right turn, and lane change in which the autonomous vehicle's heading direction is changed, the autonomous driving control apparatus 100 may normally correct a relative location of the integrated lane through a coordinate system transformation or re-transformation.

FIG. 6 is a diagram illustrating a dynamics model of a vehicle used by an autonomous driving control apparatus, according to an embodiment of the present disclosure.

The autonomous driving control apparatus 100 may calculate an expected driving route in an analytical manner through the vehicle dynamics model.

For example, the autonomous driving control apparatus 100 may calculate the expected driving route based on dynamic characteristics of an autonomous vehicle by using a known Stanley method.

When a departure angle over time and a departure distance over time satisfy a closed form condition, the autonomous driving control apparatus 100 may calculate the expected driving route by using the Stanley method.

Equation 1 and Equation 2 below may be used in a process in which the autonomous driving control apparatus 100 calculates an expected driving route by using the Stanley method.

$$\dot{e} ( t ) = v ( t ) sin ( ψ ( t ) - δ ( t ) ) \qquad [ Equation 1 ]$$

$$\dot{ψ} ( t ) = r ( t ) = - \frac{v ( t ) sin ( δ ( t ) )}{a + b} \qquad [ Equation 2 ]$$

Here, e′(t) may denote a differential value of a vertical deviation distance.

Moreover, ψ′(t) may denote a differential value of a yaw angle, i.e., a yaw rate.

For example, the autonomous driving control apparatus 100 may set a control-following route to a reference trajectory 601 and may calculate the departure distance over time and the departure angle over time. Accordingly, the autonomous driving control apparatus 100 may determine an expected driving trajectory.

For example, the autonomous driving control apparatus 100 may re-calculate the speed profile and the control-following route depending on the modified driving strategy.

FIG. 7 is a diagram illustrating that an autonomous driving control apparatus estimates an expected driving route through a numerical analysis method, according to an embodiment of the present disclosure.

When a departure angle over time and a departure distance over time do not satisfy a closed form condition, but there is information about a dynamics model of a vehicle and the autonomous driving control apparatus 100 is capable of estimating a change in the departure distance per unit time, the autonomous driving control apparatus 100 may estimate the expected driving route through a numerical analysis method.

Even though the departure angle over time and the departure distance over time do not satisfy the closed form condition, the autonomous driving control apparatus 100 may calculate e′(t) through Equation 1.

Assuming that the previous frame is “t=T₁” (701) and the next frame is “t=T₂” (702), when T₁ and T₂ are very close to each other, the autonomous driving control apparatus 100 may estimate the departure distance as shown in Equation 3 below.

e(T₂)≅e(T₁)+(T₂−T₁)·ė(t=T₁) [Equation 3]

For example, the autonomous driving control apparatus 100 may estimate an expected driving route based on the estimated departure distance.

For example, the autonomous driving control apparatus 100 may estimate an expected driving route in consideration of the initial location and driving direction of the autonomous vehicle.

However, estimation errors may be accumulated in this process. For example, in a process of estimating a departure distance between frames in an experimental method, the autonomous driving control apparatus 100 may generate and use a correction term to which a weight according to a route accumulation is reflected. Thus, the accumulated errors may be fixed.

FIG. 8 is a diagram illustrating that an autonomous driving control apparatus calculates an expected driving route through a lookup table, according to an embodiment of the present disclosure.

Referring to FIG. 8, an example lookup table may include information about a yaw rate of 0.7 deg/sec, a current departure distance of 0.1 m, a current departure angle of 10°, and a time-specific driving location (P₁(0.3, 2.4) to P_{N}(87.3, 2.1)) when the current speed is 35 km/h.

Furthermore, the lookup table may include information about the yaw rate of 0.3 deg/sec, the current departure distance of 0.3 m, the current departure angle of 17°, and the time-specific driving location (P₁(0.4, 1.4) to P_{N}(98.8, 1.1)) when the current speed is 65 km/h.

The lookup table may include information about a driving route, a yaw rate, a current departure distance, a current departure angle, and a time-specific driving location (P₁ to P_{N}) according to a variable including a current speed.

For example, in a calibration stage or manufacturing stage of an initial vehicle, the lookup table may be configured based on a database built by a manufacturer or a user.

For example, the lookup table may include a time-specific estimation location according to at least one of a control-following route, a yaw rate, a departure distance, a departure angle, a speed, or acceleration.

The lookup table may not include information about all cases. Accordingly, the autonomous driving control apparatus 100 may calculate the time-specific driving location by using a weighted average of pieces of information of the lookup table that is closest to an actual value.

For example, when information about an expected driving route or an estimation location that accurately corresponds to at least one of the autonomous vehicle's yaw rate, departure distance, departure angle, speed, or acceleration is not stored in the lookup table, the autonomous driving control apparatus 100 may calculate the expected driving route through the weighted average of information about one or more expected driving routes or estimation locations that most closely correspond to at least one of a driving vehicle's yaw rate, departure distance, departure angle, speed, or acceleration.

FIG. 9 is a diagram illustrating that an autonomous driving control apparatus calculates an expected driving route through machine learning, according to an embodiment of the present disclosure.

Referring to FIG. 9, a pre-trained learning model may use coordinates of p₀ to p_{N} as outputs by using a yaw rate 901, an initial departure distance 902, an initial departure angle 903, an initial speed 904, and an initial acceleration 905 as inputs.

The predetermined learning model may be trained through a solution of a multiple regression problem based on machine learning.

For example, the predetermined learning model may be trained by using a cross validation scheme or the like after building a train/validation/test dataset depending on a size of a data set.

For example, a recurrent neural network (RNN)-based learning model such as long short-term memory (LSTM), gated recurrent unit (GRU), or the like may be mainly used as the predetermined learning model, but is not limited thereto.

For example, the predetermined learning model may be shared between vehicles depending on a vehicle type and sensor combination and may be updated in an over-the-air (OTA) method for each vehicle.

The autonomous driving control apparatus 100 may calculate coordinates of p₀ to p_{N} by applying the yaw rate 901, the initial departure distance 902, the initial departure angle 903, the initial speed 904, and the initial acceleration 905 of a current autonomous vehicle to the pre-trained learning model and then may determine an expected driving route through the coordinates.

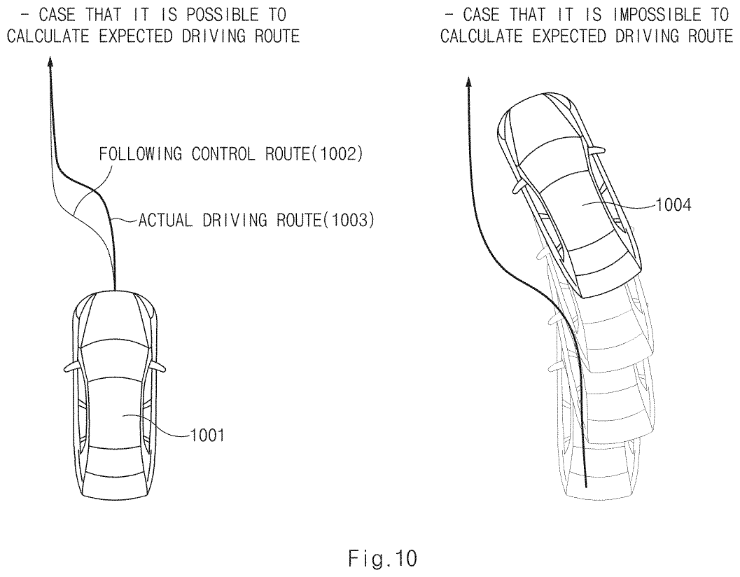

FIG. 10 is a diagram illustrating a case in which an autonomous driving control apparatus is capable of calculating an expected driving route and a case in which the autonomous driving control apparatus is incapable of calculating the expected driving route, according to an embodiment of the present disclosure.

For example, when it is possible to calculate an expected driving route, the autonomous driving control apparatus 100 may calculate a following control route 1002 and an expected actual driving route 1003 of an autonomous vehicle 1001.

The autonomous driving control apparatus 100 may determine whether the actual driving route 1003 deviates from the following control route 1002 at a future point in time by comparing the calculated following control route 1002 of the autonomous vehicle 1001 with the expected actual driving route 1003.

At this time, the autonomous driving control apparatus 100 may determine whether a difference in distance between points constituting a route is not less than a predetermined threshold value, by using L2 Norm.

The L2 Norm is not shown. However, the shortest distance between points may be calculated by calculating the L2 Norm in a method of calculating a magnitude of a vector in Euclidean space.

The equation for obtaining L2 Norm may be as Equation 4 below.

$$\begin{matrix}{L}_{2} = \sqrt{{\sum }_{i}^{n} {x}_{i}^{2}} \\ = \sqrt{{x}_{1}^{2} + {x}_{2}^{2} + {x}_{3}^{2} + … + {x}_{n}^{2}}\end{matrix} \qquad [ Equation 4 ]$$

Here, L2 may denote L2 Norm. Each of x₁, x₂, . . . , xₙ may denote a value of each component of a vector.

For example, the autonomous driving control apparatus 100 may calculate a two-dimensional or three-dimensional distance between a point on the following control route 1002 and a point on the expected actual driving route 1003 by using L2 Norm. In this case, ‘n’ in Equation 4 may be 2 or 3.

The autonomous driving control apparatus 100 may determine whether the actual driving route 1003 deviates from the following control route 1002, based on whether a difference in distance between points constituting a route is not less than a predetermined threshold value.

For example, when it is impossible to calculate the expected driving route, the autonomous driving control apparatus 100 may determine, in real time, whether the autonomous vehicle 1004 deviates from a control route.

For example, when it is determined that the autonomous vehicle 1004 deviates from the control route, the autonomous driving control apparatus 100 may change the driving strategy in response to each driving situation.

FIGS. 11-14 are diagrams illustrating that an autonomous driving control apparatus operates when a departure occurs in a U-turn situation, according to an embodiment of the present disclosure.

Referring to FIG. 11, the autonomous driving control apparatus 100 may determine whether a departure situation has occurred during U-turn (S1101).

The autonomous driving control apparatus 100 may determine whether the departure situation has occurred during U-turn (S1101) and then may calculate a box point of a front vehicle and a host vehicle lane considering a margin (S1102).

For example, the autonomous driving control apparatus 100 may set an internal region is included in a host vehicle lane region and has a boundary line shifted inward by a specific margin from opposite boundary lines.

For example, the autonomous driving control apparatus 100 may calculate a box including a part or all of a front vehicle and a box point, which is the vertex of the corresponding box, according to a predetermined algorithm.

The autonomous driving control apparatus 100 may calculate the box point of the front vehicle and the host vehicle lane considering the margin (S1102) and then may determine whether the box point is positioned in an internal region of the host vehicle lane considering the margin (S1103).

For example, the autonomous driving control apparatus 100 may determine whether at least one of box points is positioned in the internal region of the host vehicle lane considering the margin.

After determining whether the box point is positioned in the internal region of the host vehicle lane considering the margin (S1103), when it is determined that the box point is positioned in the internal region of the host vehicle lane considering the margin (YES in S1103), the autonomous driving control apparatus 100 may perform control 1 (S1104).

After determining whether the box point is positioned in the internal region of the host vehicle lane considering the margin (S1103), when it is determined that the box point is not positioned in the internal region of the host vehicle lane considering the margin (NO in S1103), the autonomous driving control apparatus 100 may perform control 2 (S1105).

A situation in which control 1 (S1104) is performed may have a greater risk of collision than a situation in which control 2 (S1105) is performed.

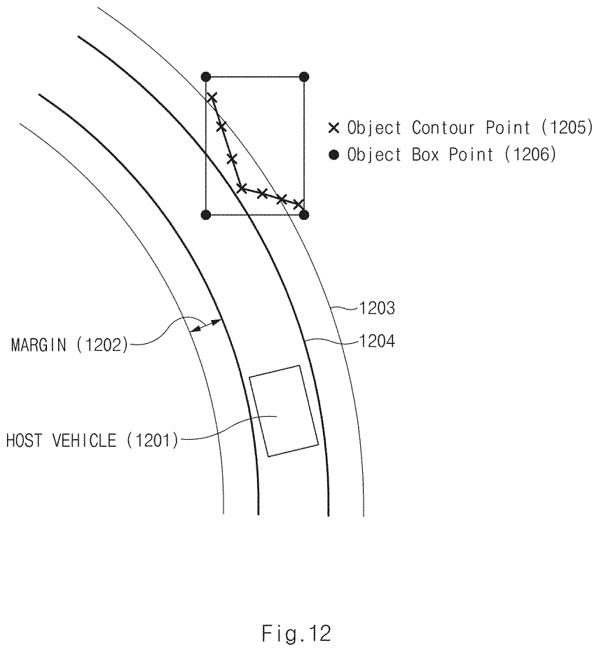

FIG. 12 is a diagram illustrating that the autonomous driving control apparatus 100 calculates a box point of a front vehicle and a host vehicle lane considering a margin.

For example, the autonomous driving control apparatus 100 may calculate an internal region according to a boundary line 1204 obtained by inwardly shifting a boundary line 1203 of an expected driving route of a host vehicle 1201 by a specific margin 1202.

A method in which the autonomous driving control apparatus 100 detects a front vehicle and expresses the front vehicle on a high definition map may include a method of expressing contour points 1205 along an actual surface of the front vehicle and a method of expressing box points 1206, which are vertices of a box including a part or all of the front vehicle depending on a predetermined algorithm.

The method using the box points 1206 may reduce the amount of computation. First of all, the autonomous driving control apparatus 100 may determine whether at least one of the box points 1206 is included in the internal region along the boundary line 1204 obtained by inwardly shifting the boundary line 1203 of the expected driving route of the host vehicle 1201 by a specific margin 1202.

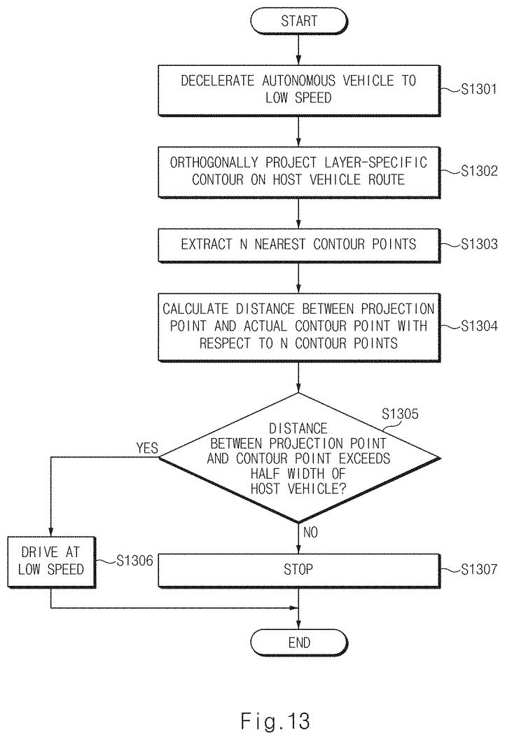

FIG. 13 is a flowchart illustrating control 1 (S1104).

Referring to FIG. 13, the autonomous driving control apparatus 100 may decelerate an autonomous vehicle to a low speed (S1301).

For example, the autonomous driving control apparatus 100 may decelerate the autonomous vehicle to a speed lower than 20 km/h. Here, 20 km/h may be a set speed for illustrative purposes and may be actually determined to another speed.

The autonomous driving control apparatus 100 may decelerate the autonomous vehicle to the low speed (S1301) and then may orthogonally project a layer-specific contour on the host vehicle route (S1302).

For example, when it is determined that a box point is positioned in an internal region of the host vehicle lane considering a margin, the autonomous driving control apparatus 100 may calculate the layer-specific contour parallel to the ground of another vehicle on the host vehicle route and then may orthogonally project the calculated layer-specific contour to accurately determine a risk of collision.

The autonomous driving control apparatus 100 may orthogonally project the layer-specific contour on the host vehicle route (S1302) and then may extract N nearest contour points (S1303).

For example, the autonomous driving control apparatus 100 may extract the N nearest points from the autonomous vehicle. The number N may be a predetermined specific number.

The autonomous driving control apparatus 100 may extract the N nearest contour points (S1303) and then may calculate a distance between a projection point and an actual contour point with respect to the N contour points (S1304).

As the distance between the projection point and the actual contour point increases, the contour of the actual other vehicle is far away from the host vehicle. Accordingly, a risk level may be low.

The autonomous driving control apparatus 100 may calculate the distance between the projection point and the actual contour point with respect to the N contour points (S1304) and then may determine whether the distance between the projection point and the contour point exceeds half the width of the host vehicle (S1305).

For example, with respect to at least one of the N nearest contour points, the autonomous driving control apparatus 100 may determine whether the distance between the projection point and the contour point exceeds half the width of the host vehicle.

After determining whether the distance between the projection point and the contour point exceeds half the width of the host vehicle (S1305), when it is determined that the distance between the projection point and the contour point exceeds half the width of the host vehicle (YES in S1305), the autonomous driving control apparatus 100 may decelerate the autonomous vehicle to a low speed (S1306).

For example, when it is determined that the distance between the projection point and the contour point exceeds half the width of the host vehicle, the risk of collision with other vehicles is relatively low. Accordingly, the autonomous driving control apparatus 100 may maintain the autonomous vehicle at a low speed lower than 20 km/h without stopping the autonomous vehicle. Here, 20 km/h may be a set speed for illustrative purposes and may be actually determined to another speed.

After determining whether the distance between the projection point and the contour point exceeds half the width of the host vehicle (S1305), when it is determined that the distance between the projection point and the contour point does not exceed half the width of the host vehicle (NO in S1305), the autonomous driving control apparatus 100 may stop the autonomous vehicle (S1307).

For example, when it is determined that the distance between the projection point and the contour point does not exceed half the width of the host vehicle, the risk of collision with other vehicles is relatively high. Accordingly, the autonomous driving control apparatus 100 may put the autonomous vehicle on a standstill until the risk of collision is resolved.

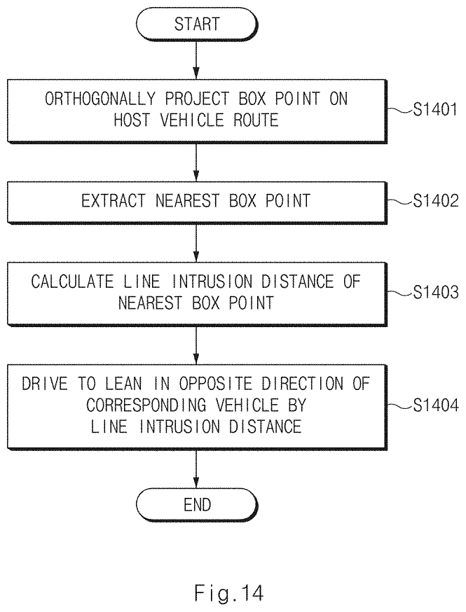

FIG. 14 is a flowchart illustrating control 2 (S1105).

Referring to FIG. 14, the autonomous driving control apparatus 100 may orthogonally project a box point on a host vehicle route (S1401).

For example, when it is determined that a box point is not in an internal region of the host vehicle lane considering a margin, the autonomous driving control apparatus 100 may determine that a sufficient margin is secured. Accordingly, the autonomous driving control apparatus 100 does not calculate the contour of another vehicle and thus may reduce the amount of computation. In addition, the autonomous driving control apparatus 100 may perform control based on the box point.

The autonomous driving control apparatus 100 may orthogonally project the box point on the host vehicle route (S1401) and then may extract the nearest box point (S1402).

The autonomous driving control apparatus 100 may extract the nearest box point (S1402) and then may calculate a line intrusion distance of the nearest box point (S1403).

For example, the autonomous driving control apparatus 100 may calculate a vertical distance at which the nearest box point violates an expected driving route based on a boundary line of the autonomous vehicle's expected driving route.

The autonomous driving control apparatus 100 may calculate a line intrusion distance of the nearest box point (S1403) and then may control the autonomous vehicle so as to be driven to lean in the opposite direction of the corresponding vehicle by the line intrusion distance (S1404).

For example, the autonomous driving control apparatus 100 may change a driving strategy such that the autonomous vehicle is driven to lean in the opposite direction of the corresponding vehicle by the line intrusion distance and then may reset a control-following route.

FIGS. 15-18 are diagrams illustrating that an autonomous driving control apparatus operates when a departure occurs in a left turn or right turn situation, according to an embodiment of the present disclosure.

FIG. 15 is a diagram illustrating that an autonomous vehicle 1501 turns to the right.

There may be a preceding vehicle 1502 that turns to the right before an autonomous vehicle 1501 in front of the autonomous vehicle 1501.

The autonomous vehicle 1501 may drive autonomously along a right-turn driving route 1504.

The right-turn driving route 1504 may have boundary lines on both sides.

At this time, there may be a cut-in vehicle 1503 is driven from a left road to a right road (a road on which a host vehicle will be driven after completing a right turn).

FIG. 15 illustrates a situation of turning to the right. However, in a situation of turning to the left, a vehicle that drives at the opposite side and then turns to the right or a vehicle that drives straight to the left on a right road may be a cut-in vehicle.

Accordingly, the autonomous driving control apparatus 100 may control autonomous driving in a similar manner even in a left-turning situation.

When the autonomous vehicle 1501 deviates from the following route, other controls may be performed depending on whether the cut-in vehicle 1503 enters between the autonomous vehicle 1501 and the preceding vehicle 1502 or whether the cut-in vehicle 1503 comes in front of the preceding vehicle 1502. Accordingly, it may be necessary to distinguish between the two cases.

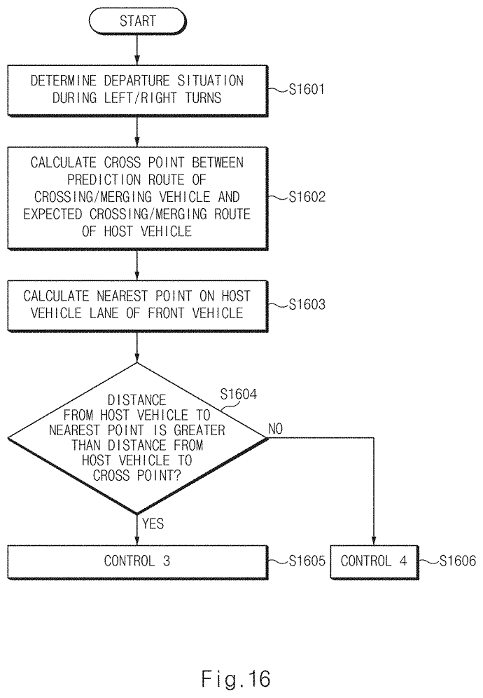

Referring to FIG. 16, the autonomous driving control apparatus 100 may determine a departure situation during left/right turns (S1601).

The autonomous driving control apparatus 100 may determine the departure situation during left/right turns (S1601) and then may calculate a cross point between a prediction route of the crossing/merging vehicle and the expected driving route of the host vehicle (S1602).

For example, the autonomous driving control apparatus 100 may receive information about the prediction route of crossing/merging vehicle by communicating with the crossing/merging vehicle or a server through V2X communication.

For example, the autonomous driving control apparatus 100 may calculate a cross point between the prediction route of the crossing/merging vehicle and the expected driving route of the host vehicle based on the high definition map information and information about a prediction route including the location, speed, acceleration, and traveling direction of the crossing/merging vehicle.

For example, the autonomous driving control apparatus 100 may correct the prediction route calculated based on the dynamics information of the crossing/merging vehicle in consideration of the high definition map.

The autonomous driving control apparatus 100 may calculate the cross point between a prediction route of the crossing/merging vehicle and the expected driving route of the host vehicle (S1602) and then may calculate the nearest point on the host vehicle lane of the front vehicle (S1603).

For example, the autonomous driving control apparatus 100 may calculate the nearest point on the host vehicle lane of the front vehicle based on the contour point of the front vehicle.

For example, the autonomous driving control apparatus 100 may calculate the nearest point on the host vehicle lane of the front vehicle at a point in time when the crossing/merging vehicle crosses/merges the expected driving route.

The autonomous driving control apparatus 100 may calculate the nearest point on the host vehicle lane of the front vehicle (S1603) and then may determine whether the distance from the host vehicle to the nearest point is greater than the distance from the host vehicle to the cross point (S1604).

After determining whether the distance from the host vehicle to the nearest point is greater than the distance from the host vehicle to the cross point (S1604), when it is determined that the distance from the host vehicle to the nearest point is greater than the distance from the host vehicle to the cross point (YES in S1604), the autonomous driving control apparatus 100 may perform control 3 (S1605).

After determining whether the distance from the host vehicle to the nearest point is greater than the distance from the host vehicle to the cross point (S1604), when it is determined that the distance from the host vehicle to the nearest point is not greater than the distance from the host vehicle to the cross point (NO in S1604), the autonomous driving control apparatus 100 may perform control 4 (S1606).

A situation in which control 3 (S1605) is performed may be a case where the crossing/merging vehicle enters between the host vehicle and the front vehicle. A situation in which control 4 (S1606) is performed may be a case in which the crossing/merging vehicle enters in front of the front vehicle.

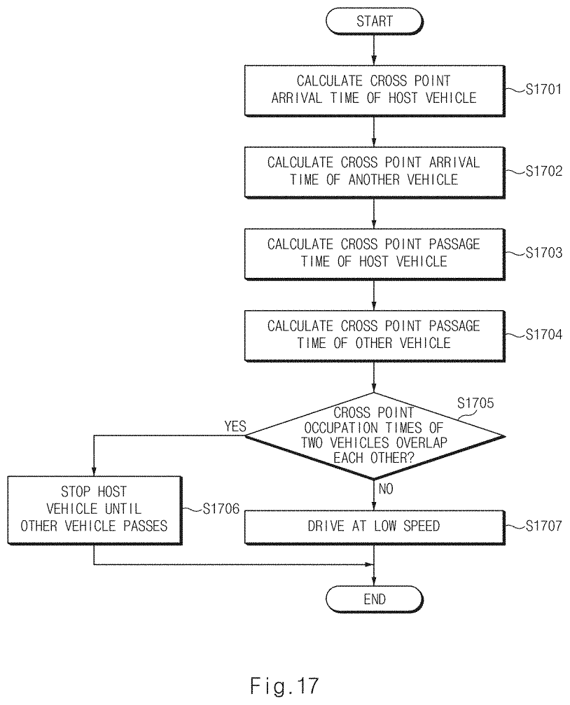

FIG. 17 is a flowchart illustrating control 3 (S1605).

Referring to FIG. 17, the autonomous driving control apparatus 100 may calculate a cross point arrival time of a host vehicle (S1701).

The cross point arrival time may mean a time at which a vehicle meets the cross point.

The autonomous driving control apparatus 100 may calculate the cross point arrival time of the host vehicle (S1701) and then may calculate a cross point arrival time of another vehicle (S1702).

The autonomous driving control apparatus 100 may calculate the cross point arrival time of the other vehicle (S1702) and then may calculate a cross point passage time of the host vehicle (S1703).

The cross point passage time may mean a time when a vehicle completely exits the cross point.

The autonomous driving control apparatus 100 may calculate the cross point passage time of the host vehicle (S1703) and then may calculate the cross point passage time of the other vehicle (S1704).

Here, S1701-S1704 may be performed in a different order, or some or all of S1701 to S1704 may be performed simultaneously.

For example, the autonomous driving control apparatus 100 may calculate the cross point arrival time and the cross point passage time of the other vehicle based on at least one of a predicted driving route or dynamics characteristics of the other vehicle.

For example, the autonomous driving control apparatus 100 may calculate the cross point arrival time and the cross point passage time of the host vehicle based on at least one of an expected driving route or dynamics characteristics of the host vehicle.

The autonomous driving control apparatus 100 may calculate the cross point passage time of the other vehicle (S1704) and then may determine whether cross point occupation times of the two vehicles overlap each other (S1705).

After determining whether the cross point occupation times of the two vehicles overlap each other (S1705), when it is determined that the cross point occupation times of two vehicles overlaps each other (YES in S1705), the autonomous driving control apparatus 100 may control the host vehicle to be stopped until the other vehicle passes first (S1706).

For example, when it is determined that the cross point occupation times of two vehicles overlaps each other, the autonomous driving control apparatus 100 may determine that a risk of collision between the two vehicles is relatively high and then may control the host vehicle to be stopped until the other vehicle passes first.

After determining whether the cross point occupation times of the two vehicles overlap each other (S1705), when it is determined that the cross point occupation times of two vehicles does not overlap each other (NO in S1705), the autonomous driving control apparatus 100 may control the host vehicle to drive at low speed (S1707).

For example, when it is determined that the cross point occupation times of two vehicles does not overlap each other, the autonomous driving control apparatus 100 may determine that a risk of collision between the two vehicles is relatively low and then may control the host vehicle to be driven at a low speed (e.g., a predetermined speed of less than 20 km/h) without stopping the host vehicle.

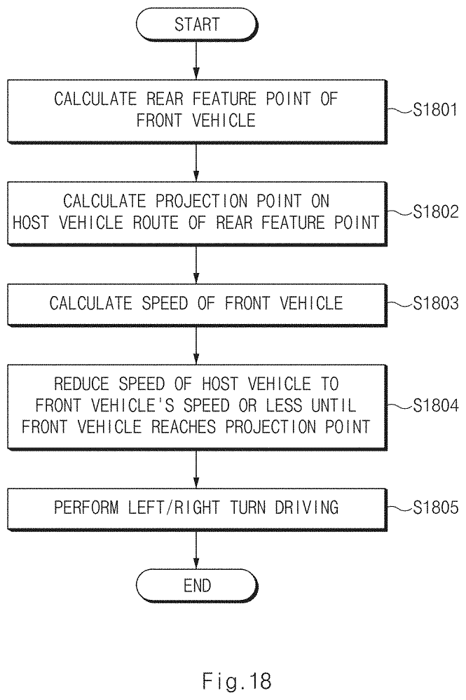

FIG. 18 is a flowchart illustrating control 4 (S1606).

Referring to FIG. 18, the autonomous driving control apparatus 100 may calculate a rear feature point of a front vehicle (S1801).

For example, the rear feature point may be a midpoint of a bumper of the front vehicle.

The autonomous driving control apparatus 100 may calculate the rear feature point of the front vehicle (S1801) and then may calculate a point obtained by orthogonally projecting the rear feature point onto a host vehicle route (S1802).

The autonomous driving control apparatus 100 may calculate the point obtained by orthogonally projecting the rear feature point onto the host vehicle route (S1802) and then may calculate a speed of the front vehicle (S1803).

For example, the autonomous driving control apparatus 100 may receive information about the speed of the front vehicle through V2X communication with the front vehicle or a server.

The autonomous driving control apparatus 100 may calculate the speed of the front vehicle (S1803) and then may reduce the speed of a host vehicle to the front vehicle's speed or less until the front vehicle reaches the projection point (S1804).

The autonomous driving control apparatus 100 may reduce the speed of a host vehicle to the front vehicle's speed or less until the front vehicle reaches the projection point (S1804) and then may perform left/right turn driving (S1805).

For example, when a crossing/merging vehicle enters in front of the front vehicle, the autonomous driving control apparatus 100 may control left/right-turn driving based on a relationship with the front vehicle rather than the crossing/merging vehicle.

FIGS. 19-23 are diagrams illustrating that an autonomous driving control apparatus operates when a departure occurs in a situation of returning to an existing lane during a lane change, according to an embodiment of the present disclosure.

FIG. 19 is a diagram illustrating that an autonomous vehicle 1901 returns to an existing lane during a lane change.

Referring to FIG. 19, the autonomous vehicle 1901 may return to a third lane, which is the existing lane, or change a lane from the third lane to a fourth lane.

Reference numeral 1903 indicates a route for returning to the third lane. Reference numeral 1904 indicates a route for changing to the fourth lane.

Virtual boundary lines 1902 of the route 1903 for returning to the third lane may be present.

A front vehicle 1905 may be present in the fourth lane to which the autonomous vehicle 1901 desires to change a lane.

A cut-in vehicle 1906 that desires to change a lane from a second lane to the third lane may be present in the third lane to which the autonomous vehicle 1901 returns.

When the autonomous vehicle 1901 deviates from a following route, other controls may be performed depending on a relationship between the autonomous vehicle 1901 and the front vehicle 1905 or whether the cut-in vehicle 1906 is present. Accordingly, it may be necessary to distinguish between the two cases.

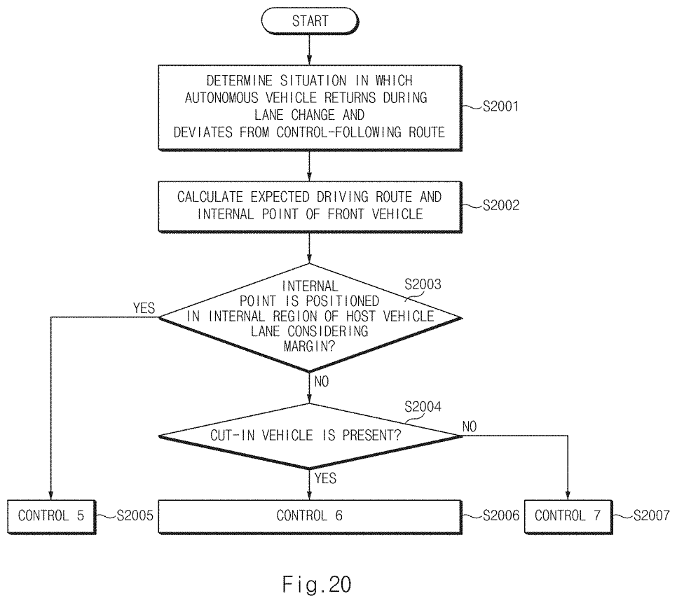

Referring to FIG. 20, the autonomous driving control apparatus 100 may determine a situation in which the autonomous vehicle 1901 returns during a lane change and deviates from a control-following route (S2001).

The autonomous driving control apparatus 100 may determine that the autonomous vehicle 1901 returns during a lane change and deviates from the control-following route (S2001) and then may calculate an expected driving route and an internal point of a front vehicle (S2002).

For example, the internal point may mean a point with the closest vertical distance to the expected driving route of the host vehicle among box points of another vehicle.

The autonomous driving control apparatus 100 may calculate an expected driving route and an internal point of a front vehicle (S2002) and then may determine whether the internal point is positioned in an internal region of a host vehicle lane considering a margin (S2003).

After determining whether the internal point is positioned in the internal region of the host vehicle lane considering the margin (S2003), when it is determined that the internal point is positioned in the internal region of the host vehicle lane considering the margin (YES in S2003), the autonomous driving control apparatus 100 may perform control 5 (S2005).

After determining whether the internal point is positioned in the internal region of the host vehicle lane considering the margin (S2003), when it is determined that the internal point is not positioned in the internal region of the host vehicle lane considering the margin (NO in S2003), the autonomous driving control apparatus 100 may determine whether a cut-in vehicle is present (S2004).

After determining whether the cut-in vehicle is present (S2004), when it is determined that the cut-in vehicle is present (YES in S2004), the autonomous driving control apparatus 100 may perform control 6 (S2006).

After determining whether the cut-in vehicle is present (S2004), when it is determined that the cut-in vehicle is not present (NO in S2004), the autonomous driving control apparatus 100 may perform control 7 (S2007).

When the internal point is positioned in the internal region of the host vehicle lane considering the margin, a risk of collision with the front vehicle may be relatively high. When a cut-in vehicle is present even though the internal point is not positioned in the internal region of the host vehicle lane considering the margin, a risk of collision with the cut-in vehicle may be present.

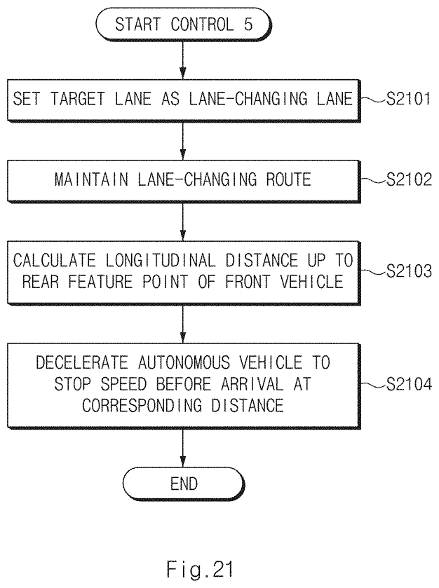

FIG. 21 is a flowchart illustrating control 5.

Referring to FIG. 21, the autonomous driving control apparatus 100 may set a target lane as a lane-changing lane (S2101).

The autonomous driving control apparatus 100 may set the target lane as the lane-changing lane (S2101) and then may maintain a lane-changing route (S2102).

When an internal point is positioned in an internal region of a host vehicle lane considering a margin, it may not be possible to safely perform a lane return due to a risk of collision with a front vehicle. Accordingly, it may be safer to perform a lane change.

The autonomous driving control apparatus 100 may maintain the lane-changing route (S2102) and then may calculate a longitudinal distance up to a rear feature point of a front vehicle (S2103).

For example, the rear feature point of the front vehicle may be a midpoint of a rear bumper of the front vehicle.

The autonomous driving control apparatus 100 may calculate a longitudinal distance up to a rear feature point of a front vehicle (S2103) and then may decelerate an autonomous vehicle to a stop speed before arrival at the corresponding distance (S2104).

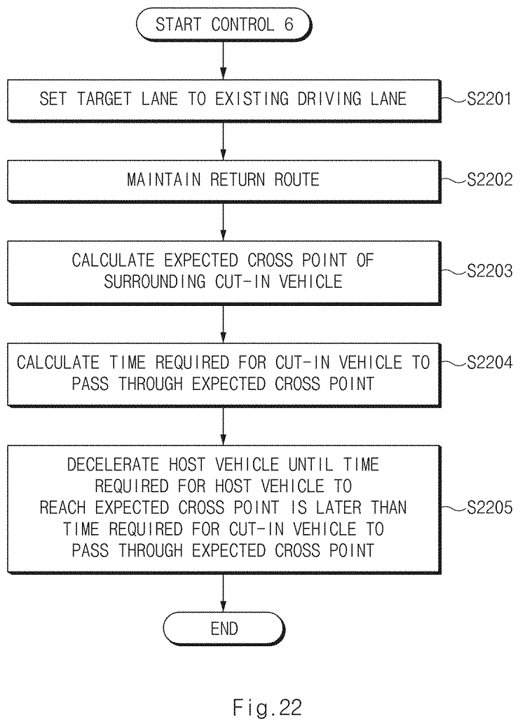

FIG. 22 is a flowchart illustrating control 6.

Referring to FIG. 22, the autonomous driving control apparatus 100 may set a target lane to an existing driving lane of a host vehicle (S2201).

The autonomous driving control apparatus 100 may set the target lane to the existing driving lane of the host vehicle (S2201) and then may maintain a return route (S2202).

When an internal point is positioned in an internal region of a host vehicle lane considering a margin, a lane return may be performed because a risk of collision with the front vehicle is relatively low. However, a risk of collision with a cut-in vehicle needs to be considered.

The autonomous driving control apparatus 100 may maintain a return route (S2202) and then may calculate the expected cross point of a surrounding cut-in vehicle (S2203).

The autonomous driving control apparatus 100 may calculate the expected cross point of the surrounding cut-in vehicle (S2203) and then may calculate a time required for the cut-in vehicle to pass through the expected cross point (S2204).

The autonomous driving control apparatus 100 may calculate the time required for the cut-in vehicle to pass through the expected cross point (S2204) and then may decelerate the host vehicle until a time required for the host vehicle to reach the expected cross point is later than a time required for the cut-in vehicle to pass through the expected cross point (S2205).

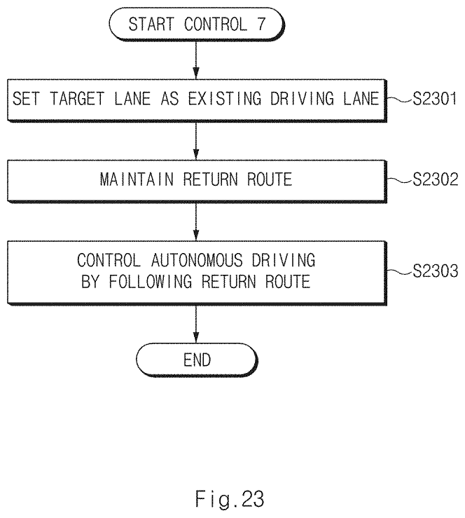

FIG. 23 is a flowchart illustrating control 7.

Referring to FIG. 23, the autonomous driving control apparatus 100 may set a target lane as an existing driving lane of a host vehicle (S2301).

The autonomous driving control apparatus 100 may set the target lane to the existing driving lane of the host vehicle (S2301) and then may maintain a return route (S2302).

When an internal point is positioned in an internal region of a host vehicle lane considering a margin, a lane return may be performed because a risk of collision with the front vehicle is relatively low. When a cut-in vehicle is not present, a risk of collision with the cut-in vehicle does not need to be considered.

The autonomous driving control apparatus 100 may maintain the return route (S2302) and then may control autonomous driving by following a return route (S2303).

FIGS. 24-28 are diagrams illustrating that an autonomous driving control apparatus operates when a departure occurs in a situation of a lane change in a stopped state, according to an embodiment of the present disclosure.

FIG. 24 is a diagram illustrating that autonomous vehicles (2401, 2404) change lanes in a stopped state.

Front vehicles (2402, 2405) may be present in the same lane as the autonomous vehicles (2401, 2404), respectively.

When the autonomous vehicles (2401, 2404) deviate from a following route, other controls may be performed depending on a case that a boundary line 2403 of an expected driving route of the autonomous vehicle 2401 does not overlap the front vehicle 2402 and depending on a case that a boundary line 2406 of an expected driving route of the autonomous vehicle 2404 overlaps the front vehicle 2405. Accordingly, it may be necessary to distinguish between the two cases.

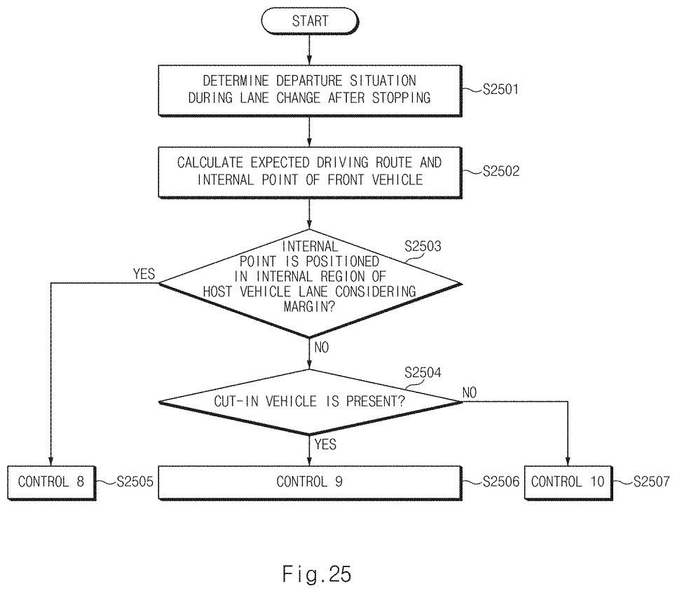

Referring to FIG. 25, the autonomous driving control apparatus 100 may determine a departure situation of a control-following route during a lane change after stopping (S2501).

The autonomous driving control apparatus 100 may determine the departure situation of the control-following route during the lane change after stopping (S2501) and then may calculate an expected driving route and an internal point of a front vehicle (S2502).

For example, the internal point may mean a point with the closest vertical distance to the expected driving route of the host vehicle among box points of another vehicle.

The autonomous driving control apparatus 100 may calculate an expected driving route and an internal point of a front vehicle (S2502) and then may determine whether the internal point is positioned in an internal region of a host vehicle lane considering a margin (S2503).

After determining whether the internal point is positioned in the internal region of the host vehicle lane considering the margin (S2503), when it is determined that the internal point is positioned in the internal region of the host vehicle lane considering the margin (YES in S2503), the autonomous driving control apparatus 100 may perform control 8 (S2505).

After determining whether the internal point is positioned in the internal region of the host vehicle lane considering the margin (S2503), when it is determined that the internal point is not positioned in the internal region of the host vehicle lane considering the margin (NO in S2503), the autonomous driving control apparatus 100 may determine whether a cut-in vehicle is present (S2504).

After determining whether the cut-in vehicle is present (S2504), when it is determined that the cut-in vehicle is present (YES in S2504), the autonomous driving control apparatus 100 may perform control 9 (S2506).

After determining whether the cut-in vehicle is present (S2504), when it is determined that the cut-in vehicle is not present (NO in S2504), the autonomous driving control apparatus 100 may perform control 10 (S2507).

When the internal point is positioned in the internal region of the host vehicle lane considering the margin, a risk of collision with the front vehicle may be relatively high. When a cut-in vehicle is present even though the internal point is not positioned in the internal region of the host vehicle lane considering the margin, a risk of collision with the cut-in vehicle may be present.

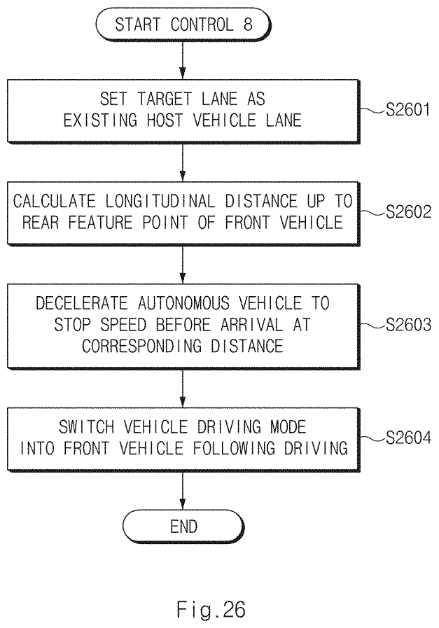

FIG. 26 is a flowchart illustrating control 8.

Referring to FIG. 26, the autonomous driving control apparatus 100 may set a target lane as an existing host vehicle lane (S2601).

The autonomous driving control apparatus 100 may set the target lane as the existing host vehicle lane (S2601) and then may calculate a longitudinal distance up to a rear feature point of a front vehicle (S2602).

For example, the rear feature point of the front vehicle may be a midpoint of a rear bumper of the front vehicle.

The autonomous driving control apparatus 100 may calculate a longitudinal distance up to a rear feature point of a front vehicle (S2602) and then may decelerate an autonomous vehicle to a stop speed before arrival at the corresponding distance (S2603).

The autonomous driving control apparatus 100 may decelerate an autonomous vehicle to a stop speed before arrival at the corresponding distance (S2603) and then may switch a vehicle driving mode into front vehicle following driving (S2604).

For example, to prevent collision with the front vehicle, the autonomous driving control apparatus 100 may perform autonomous driving control by following the front vehicle.

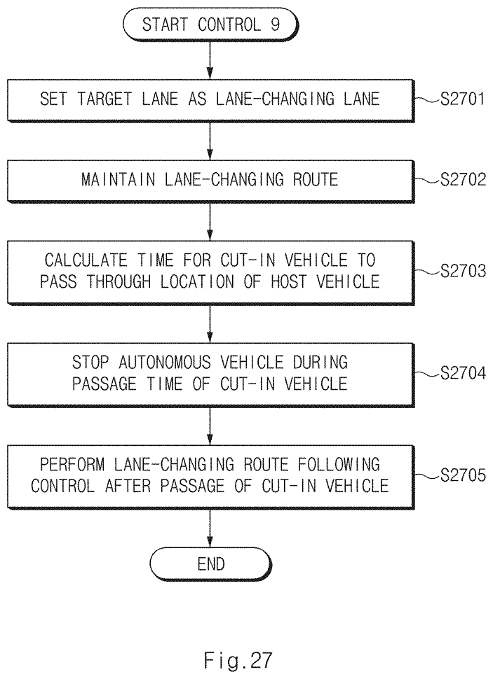

FIG. 27 is a flowchart illustrating control 9.

Referring to FIG. 27, the autonomous driving control apparatus 100 may set a target lane as a lane-changing lane (S2701).

The autonomous driving control apparatus 100 may set the target lane as the lane-changing lane (S2701) and then may maintain a lane-changing route (S2702).

The autonomous driving control apparatus 100 may maintain the lane-changing route (S2702) and then may calculate a time for the cut-in vehicle to pass through a location of a host vehicle (S2703).

The autonomous driving control apparatus 100 may calculate the time for the cut-in vehicle to pass through the location of the host vehicle (S2703) and then may control the autonomous vehicle to be stopped during a passage time of a cut-in vehicle (S2704).

The autonomous driving control apparatus 100 may control the autonomous vehicle to be stopped during the passage time of the cut-in vehicle (S2704) and then may perform a lane-changing route following control after the passage of the cut-in vehicle (S2705).

For example, a risk of collision with the cut-in vehicle disappears after the passage of the cut-in vehicle, and thus the autonomous driving control apparatus 100 may perform a lane change control by following the lane-changing route.

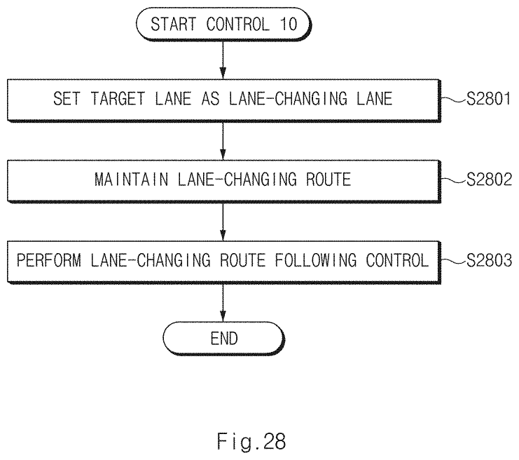

FIG. 28 is a flowchart illustrating control 10.

Referring to FIG. 28, the autonomous driving control apparatus 100 may set a target lane as a lane-changing lane (S2801).

The autonomous driving control apparatus 100 may set the target lane as the lane-changing lane (S2801) and then may maintain a lane-changing route (S2802).

The autonomous driving control apparatus 100 may maintain a lane-changing route (S2802) and then may perform a lane-changing route following control (S2803).

For example, when a cut-in vehicle is not present, there is no need to consider a risk of collision with the cut-in vehicle. The autonomous driving control apparatus 100 may perform a lane change control by following the lane-changing route.

FIGS. 29 and 30 are diagrams illustrating that an autonomous driving control apparatus operates when a deviation occurs to an extent exceeding a predetermined threshold value, according to an embodiment of the present disclosure.

FIG. 29 is a diagram illustrating that an autonomous vehicle deviates from a control-following route to an extent exceeding a predetermined threshold value.

Referring to FIG. 29, the autonomous driving control apparatus 100 may determine that an autonomous vehicle 2901 deviates from a control-following route 2902 to an extent exceeding a predetermined threshold value, by comparing the control-following route 2902 of the autonomous vehicle 2901 with an expected driving route 2903 of the autonomous vehicle 2901.

Referring to FIG. 30, the autonomous driving control apparatus 100 may determine whether an expected driving distance is output (S3001).

When the expected driving distance is output, the autonomous driving control apparatus 100 may determine that there is no serious risk of deviation from the expected driving route.

After determining whether the expected driving distance is output (S3001), when it is determined that the expected driving distance is output (YES in S3001), the autonomous driving control apparatus 100 may perform a departure situation countermeasure (S3003).

For example, when the expected driving distance is output, the autonomous driving control apparatus 100 may perform a departure situation countermeasure control corresponding to each driving situation.

After determining whether the expected driving distance is output (S3001), when it is determined that the expected driving distance is not output (NO in S3001), the autonomous driving control apparatus 100 may determine whether a departure distance exceeds a threshold value (S3002).

After determining whether the departure distance exceeds the threshold value (S3002), when it is determined that the departure distance does not exceed the threshold value (NO in S3002), the autonomous driving control apparatus 100 may perform a departure situation countermeasure (S3003).

After determining whether the departure distance exceeds the threshold value (S3002), when it is determined that the departure distance exceeds the threshold value (YES in S3002), the autonomous driving control apparatus 100 may perform a MRM countermeasure (S3004).

For example, the autonomous driving control apparatus 100 may perform MRM countermeasure control, such as stopping after deceleration in a driving lane, stopping after a change to a shoulder lane, or the like.

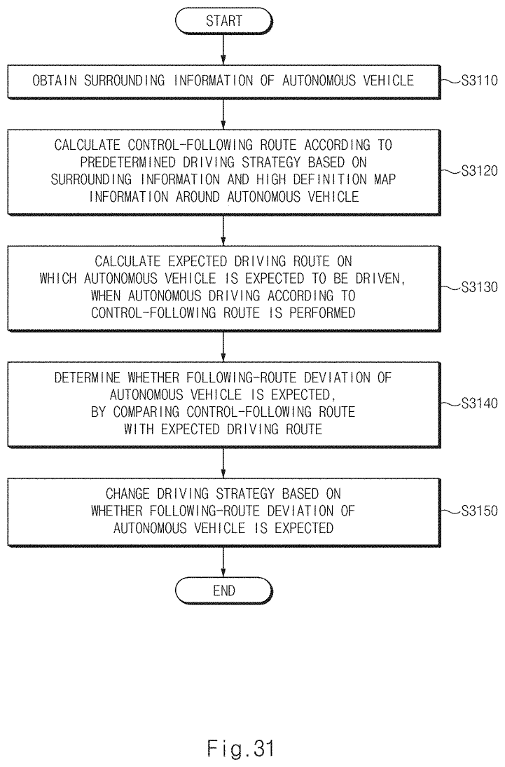

FIG. 31 is a flowchart illustrating an autonomous driving control method, according to an embodiment of the present disclosure.

Referring to FIG. 31, an autonomous driving control method may include obtaining surrounding information of an autonomous vehicle (S3110). The method may include calculating a control-following route according to a predetermined driving strategy based on the surrounding information and high definition map information around the autonomous vehicle (S3120). The method may also include calculating an expected driving route on which the autonomous vehicle is expected to be driven, when autonomous driving according to the control-following route is performed (S3130). The method may also include determining whether following-route deviation of the autonomous vehicle is expected, by comparing the control-following route with the expected driving route (S3140). The method may also include changing the driving strategy based on whether the following-route deviation of the autonomous vehicle is expected (S3150).

The obtaining (S3110) of the surrounding information of the autonomous vehicle may be performed by the sensor 110.

The calculating (S3120) of the control-following route according to the predetermined driving strategy based on the surrounding information and the high definition map information around the autonomous vehicle may be performed by the controller 130.

The calculating (S3130) of the expected driving route on which the autonomous vehicle is expected to be driven, when autonomous driving according to the control-following route is performed may be performed by the controller 130.

For example, the calculating (S3130) of the expected driving route may include calculating, by the controller 130, a departure angle over time and a departure distance over time by using a dynamics model of the autonomous vehicle and calculating, by the controller 130, the expected driving route based on the departure angle over time and the departure distance over time.

For example, the calculating (S3130) of the expected driving route may include calculating, by the controller 130, the expected driving route by applying at least one of a yaw rate, a departure distance, a departure angle, a speed, or acceleration of the autonomous vehicle to a pre-trained machine learning-based learning model that uses a predetermined lookup table or a location difference between a point on the control-following route and a corresponding point on the expected driving route as an output.

The determining (S3140) of whether the following-route deviation of the autonomous vehicle is expected, by comparing the control-following route with the expected driving route may be performed by the controller 130.

The changing (S3150) of the driving strategy based on whether the following-route deviation of the autonomous vehicle is expected may be performed by the controller 130.

For example, the changing (S3150) of the driving strategy may include changing, by the controller 130, the driving strategy in consideration of a risk of collision with another vehicle determined based on the expected driving route and vertices of a virtual box including all or part of the another vehicle when the following-route deviation of the autonomous vehicle is expected, and the autonomous vehicle makes a U-turn.

For example, the changing (S3150) of the driving strategy may include determining, by the controller 130, whether a cut-in vehicle crosses or merges between the autonomous vehicle and a preceding vehicle based on a cross point between the expected driving route and a driving route of the cut-in vehicle and a nearest point with the preceding vehicle on the expected driving route, when the following-route deviation the autonomous vehicle is expected and when the autonomous vehicle turns to a left or a right. The changing (S3150) of the driving strategy may also include changing, by the controller 130, the driving strategy in consideration of whether the determined cut-in vehicle crosses or merges between the autonomous vehicle and the preceding vehicle.

For example, the changing (S3150) of the driving strategy may include changing, by the controller 130, the driving strategy in consideration of a point with a closest vertical distance to the expected driving route among vertices of a virtual box including all or part of another vehicle and in consideration of whether there is a cut-in vehicle in an existing lane, when the following-route deviation of the autonomous vehicle is expected and when the autonomous vehicle returns to the existing lane during a lane change.

For example, the changing (S3150) of the driving strategy may include changing, by the controller 130, the driving strategy so as to perform a MRM control, when a difference between the control-following route and the expected driving route exceeds a predetermined threshold value.

The operations of the method or algorithm described in connection with the embodiments disclosed in the specification may be directly implemented with a hardware module, a software module, or a combination of the hardware module and the software module, which is executed by the processor. The software module may reside on a storage medium (i.e., the memory and/or the storage) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor. The processor may read out information from the storage medium and may write information in the storage medium. Alternatively, the storage medium may be integrated with the processor. The processor and storage medium may be implemented with an application specific integrated circuit (ASIC). The ASIC may be provided in a user terminal. Alternatively, the processor and storage medium may be implemented with separate components in the user terminal.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure. Embodiments of the present disclosure provided only for the illustrative purpose. The scope of protection of the present disclosure should be construed by the attached claims, and all equivalents thereof should be construed as being included within the scope of the present disclosure.

Descriptions of an autonomous driving control apparatus according to an embodiment of the present disclosure and descriptions of a method thereof are as follows.

According to at least one of embodiments of the present disclosure, it is possible to provide an autonomous driving control apparatus that determines following-route deviation of an autonomous vehicle and to provide a method thereof.

Furthermore, according to at least one of embodiments of the present disclosure, it is possible to provide an autonomous driving control apparatus that stably performs autonomous driving control and to provide a method thereof.

Moreover, according to at least one of embodiments of the present disclosure, it is possible to provide an autonomous driving control apparatus that prevents accidents caused by departure from a control-following route in advance by determining the following-route deviation of an autonomous vehicle and to provide a method thereof.

Also, according to at least one of embodiments of the present disclosure, it is possible to provide an autonomous driving control apparatus that facilitates data acquisition regarding control-following route departure cases and to provide a method thereof.

Besides, according to at least one of embodiments of the present disclosure, it is possible to provide an autonomous driving control apparatus that is capable of, in real time, coping with situations in which a vehicle deviates from a control-following route even when it is impossible to predict whether the vehicle deviates from the control-following route, in advance and to provide a method thereof.

Further, a variety of effects directly or indirectly understood through the specification may be provided.

What is claimed is:

1. An autonomous driving control apparatus comprising:
a sensor configured to obtain surrounding information of an autonomous vehicle;
a storage configured to store high definition map information around the autonomous vehicle; and
a controller configured to
calculate a control-following route according to a predetermined driving strategy based on the surrounding information and the high definition map information,
calculate an expected driving route on which the autonomous vehicle is expected to be driven, when autonomous driving according to the control-following route is performed,
determine whether following-route deviation of the autonomous vehicle is expected, by comparing the control-following route with the expected driving route, and
change the driving strategy based on whether the following-route deviation of the autonomous vehicle is expected.

2. The autonomous driving control apparatus of claim 1, wherein the controller is configured to:
calculate or estimate a departure angle over time and a departure distance over time by using a dynamics model of the autonomous vehicle; and
calculate or estimate the expected driving route based on the departure angle over time and the departure distance over time.

3. The autonomous driving control apparatus of claim 1, wherein the controller is configured to:
calculate an expected driving route by applying at least one of a yaw rate, a departure distance, a departure angle, a speed, or acceleration of the autonomous vehicle to a predetermined lookup table.

4. The autonomous driving control apparatus of claim 1, wherein the controller is configured to:
calculate the expected driving route by applying at least one of a yaw rate, a departure distance, a departure angle, a speed, or acceleration of the autonomous vehicle to a pre-trained machine learning-based learning model that uses a location difference between a point on the control-following route and a corresponding point on the expected driving route as an output.

5. The autonomous driving control apparatus of claim 1, wherein the controller is configured to:
change the driving strategy in consideration of a risk of collision with another vehicle determined based on the expected driving route and vertices of a virtual box including all or part of the another vehicle when the following-route deviation of the autonomous vehicle is expected and when the autonomous vehicle makes a U-turn.

6. The autonomous driving control apparatus of claim 5, wherein the controller is configured to:
decelerate the autonomous vehicle and change the driving strategy in consideration of the risk of collision with the another vehicle that is determined based on an actual boundary point of the another vehicle such that the autonomous vehicle is driven at low speed or is stopped, when one or more of the vertices are included in a region inside the expected driving route set in consideration of a specific margin; and
change the driving strategy based on an extent, to which the vertices violate the expected driving route, such that the autonomous vehicle is driven to lean in an opposite direction of the another vehicle in the control-following route, when one or more of the vertices are not included in the region inside the expected driving route set in consideration of the specific margin.

7. The autonomous driving control apparatus of claim 1, wherein the controller is configured to:
determine whether a cut-in vehicle crosses or merges between the autonomous vehicle and a preceding vehicle based on a cross point between the expected driving route and a driving route of the cut-in vehicle and a nearest point with the preceding vehicle on the expected driving route, when the following-route deviation the autonomous vehicle is expected and when the autonomous vehicle turns to a left or a right; and
change the driving strategy in consideration of whether the determined cut-in vehicle crosses or merges between the autonomous vehicle and the preceding vehicle.

8. The autonomous driving control apparatus of claim 7, wherein the controller is configured to:
change the driving strategy based on whether time periods, at which the autonomous vehicle and the cut-in vehicle occupy the cross point, overlap each other, such that the autonomous vehicle is driven at a low speed or is stopped, when it is determined that the cut-in vehicle crosses or merges between the autonomous vehicle and the preceding vehicle; and
change the driving strategy in consideration of a speed of the preceding vehicle such that the autonomous vehicle is decelerated, when it is determined that the cut-in vehicle does not cross or merge between the autonomous vehicle and the preceding vehicle.

9. The autonomous driving control apparatus of claim 1, wherein the controller is configured to:
change the driving strategy in consideration of a point with a closest vertical distance to the expected driving route among vertices of a virtual box including all or part of another vehicle and whether there is a cut-in vehicle in an existing lane, when the following-route deviation of the autonomous vehicle is expected and when the autonomous vehicle returns to the existing lane during a lane change.

10. The autonomous driving control apparatus of claim 9, wherein the controller is configured to:
change the driving strategy such that the autonomous vehicle is decelerated, while performing the lane change, when the closest point is positioned in an internal region of the expected driving route set in consideration of a specific margin;
change the driving strategy based on a cross point between the expected driving route and a driving route of the cut-in vehicle such that the autonomous vehicle is decelerated, while performing a lane return, when the closest point is not positioned in the internal region and when the cut-in vehicle is present; and
maintain the driving strategy of the lane return, when the closest point is not positioned in the internal region, and the cut-in vehicle is not present.

11. The autonomous driving control apparatus of claim 1, wherein the controller is configured to:
change the driving strategy in consideration of a point with a closest vertical distance to the expected driving route among vertices of a virtual box including all or part of another vehicle, and whether there is a cut-in vehicle in a target lane of the lane change, when the following-route deviation of the autonomous vehicle is expected and when the autonomous vehicle changes lanes while being stopped.

12. The autonomous driving control apparatus of claim 11, wherein the controller is configured to:
change the driving strategy such that the autonomous vehicle is decelerated, while not performing the lane change, when the closest point is positioned in an internal region of the expected driving route set in consideration of a specific margin;
change the driving strategy based on a cross point between the expected driving route and a driving route of the cut-in vehicle such that the autonomous vehicle is decelerated or is driven after stopping during a specific time, while performing the lane change, when the closest point is not positioned in the internal region and when the cut-in vehicle is present; and
maintain the driving strategy of the lane change, when the closest point is not positioned in the internal region and when the cut-in vehicle is not present.

13. The autonomous driving control apparatus of claim 1, wherein the controller is configured to:
change the driving strategy so as to perform a minimal risk maneuver (MRM) control, when a difference between the control-following route and the expected driving route exceeds a predetermined threshold value.

14. An autonomous driving control method, the method comprising:
obtaining, by a sensor, surrounding information of an autonomous vehicle;
calculating, by a controller, a control-following route according to a predetermined driving strategy based on the surrounding information and high definition map information around the autonomous vehicle;
calculating, by the controller, an expected driving route on which the autonomous vehicle is expected to be driven, when autonomous driving according to the control-following route is performed;
determining, by the controller, whether following-route deviation of the autonomous vehicle is expected, by comparing the control-following route with the expected driving route; and
changing, by the controller, the driving strategy based on whether the following-route deviation of the autonomous vehicle is expected.

15. The method of claim 14, wherein the calculating, by the controller, of the expected driving route includes:
calculating, by the controller, a departure angle over time and a departure distance over time by using a dynamics model of the autonomous vehicle; and
calculating, by the controller, the expected driving route based on the departure angle over time and the departure distance over time.

16. The method of claim 14, wherein the calculating, by the controller, of the expected driving route includes:
calculating, by the controller, the expected driving route by applying at least one of a yaw rate, a departure distance, a departure angle, a speed, or acceleration of the autonomous vehicle to a pre-trained machine learning-based learning model that uses a predetermined lookup table or a location difference between a point on the control-following route and a corresponding point on the expected driving route as an output.

17. The method of claim 14, wherein the changing, by the controller, of the driving strategy includes:
changing, by the controller, the driving strategy in consideration of a risk of collision with another vehicle determined based on the expected driving route and vertices of a virtual box including all or part of the another vehicle when the following-route deviation of the autonomous vehicle is expected and when the autonomous vehicle makes a U-turn.

18. The method of claim 14, wherein the changing, by the controller, of the driving strategy includes:
determining, by the controller, whether a cut-in vehicle crosses or merges between the autonomous vehicle and a preceding vehicle based on a cross point between the expected driving route and a driving route of the cut-in vehicle and a nearest point with the preceding vehicle on the expected driving route, when the following-route deviation the autonomous vehicle is expected and when the autonomous vehicle turns to a left or a right; and
changing, by the controller, the driving strategy in consideration of whether the determined cut-in vehicle crosses or merges between the autonomous vehicle and the preceding vehicle.

19. The method of claim 14, wherein the changing, by the controller, of the driving strategy includes:
changing, by the controller, the driving strategy in consideration of a point with a closest vertical distance to the expected driving route among vertices of a virtual box including all or part of another vehicle and whether there is a cut-in vehicle in an existing lane, when the following-route deviation of the autonomous vehicle is expected and when the autonomous vehicle returns to the existing lane during a lane change.

20. The method of claim 14, wherein the changing, by the controller, of the driving strategy includes:
changing, by the controller, the driving strategy so as to perform a minimal risk maneuver (MRM) control, when a difference between the control-following route and the expected driving route exceeds a predetermined threshold value.
